(19) United States
(12) Patent Application Publication
(10) Pub. No.: US 2025/0037894 A1
(43) Pub. Date: Jan. 30, 2025

(54) RADIONUCLIDE PRODUCTION METHOD, TARGET HOLDING DEVICE FOR QUANTUM BEAM IRRADIATION, SYSTEM, AND TARGET

(71) Applicants: Metal Technology Co., Ltd., Tokyo (JP); RIKEN, Saitama (JP)

(72) Inventors: Hiroshi Arata, Kanagawa (JP); Shingo Nakamura, Kanagawa (JP); Takashi Kurihara, Kanagawa (JP); Hiromitsu Haba, Saitama (JP)

(21) Appl. No.: 18/713,123

(22) PCT Filed: Nov. 24, 2022
(86) PCT No.: PCT/JP2022/043283

§ 371 Date: May 23, 2024

(30) Foreign Application Priority Data
Nov. 24, 2021 (JP) 2021-190640

(51) Int. Cl. G21G 1/04; G21G 1/00; G21K 5/08

(52) U.S. Cl. CPC G21G 1/04; G21G 1/001; G21K 5/08; G21G 2001/0094

(57) ABSTRACT

A method of producing radionuclides includes installation, irradiation, transport, and trapping steps. In the installation step, a target material containing a target nuclide is placed inside a target chamber. In the irradiation step, at least a portion of the target material is irradiated with a quantum beam. In the transport stage, a carrier gas is supplied to the inside of the target chamber and an ambient gas around the target material is sent to the outside of the target chamber through an exhaust pipe. In the trapping step, a trap device connected to the exhaust pipe is configured to trap the radionuclides produced from the target nuclide from the ambient gas. In some cases, a target holding device for quantum beam irradiation comprising a target material container and a rotational drive mechanism is also provided, as well as a quantum beam irradiation system. An example target material container is rotatable.

### BACKGROUND

### Technical Field

The present disclosure relates to radionuclide production methods and to target holding devices, systems, and targets for quantum beam irradiation. More particularly, the present disclosure relates to a highly practical method of producing radionuclides and a target holding device, system, and target for quantum beam irradiation.

### Description of the Related Art

The process of irradiating a target with radiation and a particle beam (collectively called a quantum beam), such as a charged particle beam, neutron beam, or gamma ray, is used to generate a secondary particle such as an x-ray or neutron beam, to produce a radioisotope (RI), or for other purposes. The target to be irradiated with a quantum beam can be classified into three types according to its physical state: solid target, liquid target, and gaseous target. The target material and irradiation method are selected according to the purpose and irradiation conditions, and solid targets with simple structures are commonly used. However, if the energy density of the quantum beam to be irradiated is high, problems specific to solid targets may occur. For example, cooling may be required to keep the target temperature below the melting point to prevent the target material from melting and losing its shape as a target material. Thermal stresses may also arise due to the difference in linear expansion coefficients between the target material and the substrate to which it is attached. This is another problem caused by the large heat load. Material degradation when the target material is bombarded by the quantum beam and target damage due to high radiation fields can also be a problem. These factors make it difficult to extend the service life of solid targets (e.g., Patent Document 1).

In contrast, a liquid target has a high heat load tolerance. This is because the liquid can be circulated and the movement of the target itself also serves as a heat transfer. Moreover, irradiation damage by the quantum beams is not a problem for liquid targets. However, liquid targets also have inherent problems. For example, if the liquid target is a high-melting-point material such as a metal, a preheating process is required to maintain the target in a molten state, and a heat exchanger is necessary to keep the target material molten during irradiation and to remove excess heat added by the quantum beam when its energy density is high. Employing high melting point materials as liquid targets requires sensitive control at high temperatures. In addition, piping for refrigerant, pumps, tanks, etc., are required, resulting in extensive equipment, which is not only technically but also economically problematic. Even if this problem were overcome, various difficulties await the liquid target, especially for high-melting-point materials, such as flow stabilization, corrosion of the flow path, erosion, inspection and maintenance, depending on the material (e.g., Non-Patent Document 1).

In recent years, various radioisotopes (radionuclides) have been employed in nuclear medicine for radiotherapy and tracers, and quantum beams from accelerators and other sources are used for their production. One of the most notable alpha-ray emitting nuclides that can be produced artificially is astatine 211 (²¹¹At). ²¹¹At is a halogen group element with a melting point of 302° C. and a boiling point of 337° C. It is a sublimable solid at room temperature (20° C.). ²¹¹At is produced by irradiating bismuth 209 (²⁰⁹Bi) with an alpha particle beam, and ²¹¹At production for research purposes has already been carried out (Non-Patent Document 2). In the conventional ²¹¹At production method, a solid target of ²⁰⁹Bi is irradiated with an α-particle beam, and the ²¹¹At produced by transmutation is separated and collected by a chemical separation system (id.) It is also known to use aerosols of potassium chloride (KCl) and other aerosols for the purpose of RI recovery (Non-Patent Document 3). An example of inflow of aerosol from outside for the collection of At has also been disclosed (Patent Document 2).

### CITATION LIST

### Patent Documents

Patent Document 1: JP 2016-136499 A
Patent Document 2: JP 2021-184366 A
Patent Document 3: WO2020/175027

### Non-Patent Documents

Non-Patent Document 1: “Lecture Note: Liquid Metal as the Neutron Source,” [in Japanese] J. Plasma Fusion Res. Vol. 94, No. 7, p. 349-354; No. 8, p. 420-426; No. 9, p. 449-457 (2018)
Non-Patent Document 2: Hiromitsu Haba, “Production of Radioisotopes for Targeted Radionuclide Therapy at RIKEN”, [in Japanese] Drug Delivery System, Vol. 35, No. 2, p. 114-120 (2020) DOI: 10.2745/dds. 35.114
Non-Patent Document 3: Hiromitsu Haba, “Production of Radioisotopes for Application Studies at RIKEN RI Beam Factory”, [in Japanese] KASOKUKI [Journal of Particle Accelerator Society of Japan] Vol. 12, No. 4, p.206-212 (2015)

### BRIEF SUMMARY

In order to utilize only solid targets or only liquid targets as target materials to irradiate with a quantum beam, specific issues must be addressed. When a solid target, which has a property of melting when irradiated with a high density quantum beam, is irradiated while it is kept solid, the density of the quantum beam must be limited, and/or facilities for cooling are required. When using a target that is solid before irradiation but may melt during irradiation, or when irradiating a liquid target, temperature control is necessary just to maintain the target material in a state suitable for irradiation, requiring large-scale and high-precision facilities.

Furthermore, the necessity of distinguishing between solid and liquid targets with separate treatments using conventional methods introduces complications. The requirement to differentiate the temperature at the time of irradiation according to whether it is lower or higher than the melting point of the target material itself necessitates the use of dedicated equipment for the target, according to whether it is a solid or liquid target. This may even lead to complications in the preparation for the irradiation process and its procedures.

Moreover, a method for mass production and supply of ²¹¹At, which is produced by irradiating ²⁰⁹Bi with an α-particle beam as a target material, is being studied (e.g., Non-Patent Document 2). However, a method for efficiently producing ²¹¹At in a large scale and collecting it in high yield has not yet been developed, and no suitable fabrication equipment structure is known. The conventional process of using chemical separation equipment to produce ²¹¹At involves manual chemical manipulations by operators, which require radiation protection and are labor-intensive. Such operations should be minimized. In the case of using ²⁰⁹Bi as a target material, it has conventionally required time-consuming preparations such as forming a Bi thin film on a substrate by vapor deposition or the like prior to use.

The present disclosure addresses at least one of the above-mentioned issues. That is, the present disclosure provides a new method for producing radionuclides that can facilitate the production of radionuclides and increase the practicality of quantum beam irradiation itself, as well as a target holding device, system, and target for quantum beam irradiation.

The inventors have conceived a method of producing radionuclides by utilizing the properties of gases in the production of radionuclides by irradiating them with a quantum beam. Specifically, we found that at least some of the above-mentioned problems can be solved by utilizing a heated exhaust pipe to transport ambient gas from an enclosure (target chamber) surrounding a target material to be irradiated with a quantum beam and collecting the produced radionuclides (which may also include their descendant radionuclides, the same applies hereinafter) from that ambient gas. The disclosure of the present application was thus completed. We have also found that at least some of the above-mentioned problems can be solved by applying centrifugal force to the target material using rotation, and have completed the disclosure of the present application.

That is, in an embodiment of the present disclosure, provided is a method for producing a radionuclide by quantum beam irradiation, comprising an installation step for placing a target material containing a target nuclide for quantum beam irradiation inside a target chamber in which the target material can be irradiated with a quantum beam from a quanta generator; an irradiation step in which at least a portion of the target material is irradiated with the quantum beam; a transport step in which a carrier gas is supplied to the inside of the target chamber and an ambient gas surrounding the target material is sent to the outside of the target chamber through an exhaust pipe; and a trapping step in which a trap device connected to the exhaust pipe is configured to trap from the ambient gas at least one of the first radionuclide produced from the target nuclide by the quantum beam irradiation or the second radionuclide, which is at least one of the descendant nuclides obtained from the first radionuclide through radioactive decay.

In an embodiment of the present disclosure, provided is method for quantum beam irradiation, comprising an installation step, in which a target material for quantum beam irradiation is placed in a containing part of a target material container, the target material container having the containing part and an opening through which the containing part is connected to an external environment and being rotatable around an axis of rotation passing through the containing part and the opening; a rotational drive step for rotating the target material container about the axis of rotation; and an irradiation step for irradiating at least a part of the target material with a quantum beam by irradiating with a quantum beam having an irradiation axis passing through the opening and the containing part while the target material container is rotated.

In an embodiment of the present disclosure, provided is a target holding device for quantum beam irradiation, comprising: a target material container having a containing part for a target material to be irradiated with a quantum beam and an opening through which the containing part is connected to an external environment and is rotatable about an axis of rotation passing through the containing part and the opening, and a rotational drive mechanism for generating a drive force for rotation of the target material container.

In the present disclosure, also provided are a target holding device, system and target that are suitable for use with the methods for producing a radionuclide and for quantum beam irradiation.

In this application, a quantum beam may include a radiation and a particle beam, which may include a charged particle beam, a neutron beam or a gamma ray, as exemplified above, and more specifically, an alpha particle beam, an electron beam, a proton beam, and a heavy particle beam. A quanta generator may refer to any device for generating a quantum beam, which may be, for example, a particle accelerator if the quantum beam is an alpha-particle beam. Target chamber generally means a box or enclosure for artificially controlling the environment of the target material, such that its interior can be kept airtight if necessary. Carrier gas refers to any type of gas that can perform the function of transporting materials that may contain produced radionuclides (radioactive materials). Ambient gas generally refers to any gas around the target material that can contain both the carrier gas and the radioactive material carried by the carrier gas. The carrier gas can be a single gas or a mixture of gases, and the ambient gas can contain any substance other than the carrier gas and the radioactive material carried by the carrier gas.

A descendant nuclide is a radioactive nuclide that has experienced one or more radioactive decays. Typically, it includes a daughter nuclide produced from a parent nuclide by some radioactive decay and, furthermore, a grandchild nuclide produced from the daughter nuclide. In any of the aspects of the present disclosure, the number of generations of the descendant nuclide from the parent nuclide is not limited.

The term “radionuclide” is used to distinguish and identify a nucleus that exhibits radioactivity, even to the extent of its nuclear spin state, if necessary. In this application, when referring specifically to the first and second radionuclides, the first radionuclide refers to a radionuclide that is directly produced by a nuclear reaction. In contrast, the second radionuclide is a radionuclide that is different from the first radionuclide when the distinction is made to include the nuclear spin state, if necessary. The second radionuclide itself is also radioactive and is at least one of the descendants of the first radionuclide. By applying the definition of a descendant nuclide, any daughter nuclide that was obtained by subsequent radioactive decay from a nuclide that should be classified as a second radionuclide for a given first radionuclide should also be classified as a second radionuclide for the said first radionuclide.

The terms “trap” and “trap device” refer to any phenomenon and device for collecting, trapping, or separating substances from ambient gases by absorption, chemisorption, physical adsorption, filtering, chemical reaction, centrifugation, condensation or distillation, recrystallization, precipitation, dissolution, dispersion, or any other mechanism. Since various phenomena can occur when the ambient gas is comprised of a carrier gas mixed with a collection target, the phenomena for trapping in this disclosure are not limited to any particular ones. In the case where the radionuclide to produce is ²¹¹At, a typical example of a trap device that can be a cold trap includes a gold foil trap or an activated carbon column (activated carbon filter) maintained at an appropriate temperature. The At trapped in the cold trap is collected by washing with chloroform, methanol, or deionized water. Therefore, the gold foil trap and activated carbon column are also traps for testing to see if At was able to escape from the chamber. A trap device in this disclosure includes any device other than these, and in addition to those intended to collect radionuclides such as ²¹¹At as a manufactured product, it also includes any device designed to suppress the emission of radionuclides to the outside.

Multiple steps being carried out in parallel means that there is at least a moment in time when all of those multiple steps are carried out at the same time. Conversely, it is also assumed that multiple steps that are not explicitly stated to be carried out in parallel, or multiple steps that are only described as possible to be carried out in parallel, may be carried out without overlapping in time.

The axis of rotation is a straight line of infinite length that provides the central axis for the rotational motion imparted to a target material container. A physical structure, such as a spindle, may or may not exist along that axis of rotation. For this reason, the axis of rotation passing through an object means only that the geometric line that serves as the axis of rotation passes through that object. The target material is the object to which a quantum beam is irradiated in the quantum irradiation process, and with which the quanta are impinged with a velocity or flux depending on the intensity of the beam. Target materials include metals, organic and inorganic materials, and mixtures thereof, which are made in the state of any solid, liquid, and mixtures of solids and liquids, and are not limited in material or element. The target material container is employed to contain the target material and to ensure proper retention of the target material in the irradiation of a quantum beam, such as a charged particle beam, neutron beam or gamma beam. The containing part of the target material container is a spatial area that is shaped arbitrarily to contain the target material. The opening is a surface area through which the containing part can be connected to the outside. The target is collectively the target material and the target material container, meaning an object with the target material contained in the target material container. In this case, whether the target material is integrated with the target material container or fixed to the target material container is not particularly relevant.

In any of the aspects of the present disclosure, the target material in any of the states of solid, liquid, or a mixture thereof can be employed for quantum beam irradiation. This allows any of the aspects of the present disclosure to expand the range of processing temperatures of the target material in the process of quantum beam irradiation, and also allows processing the target material regardless of whether the physical state of the target material is solid, liquid, or a mixture of the two. Any of the aspects of the present disclosure can be used with a target that has a simple structure and offers flexibility in the selection of materials. Any of the aspects of the present disclosure can increase the amount of radionuclide produced or improve the yield of the produced radionuclide, thereby increasing the practicality in the method of producing radionuclides.

### BRIEF DESCRIPTION OF THE SEVERAL VIEWS OF THE DRAWINGS

FIG. 1 is a schematic diagram of a quantum beam irradiation system of an embodiment of the present disclosure.

FIG. 2 is an enlarged cross-sectional view near the target holding device in a quantum beam irradiation system of an embodiment of the present disclosure.

FIGS. 3A-3C are a schematic diagram showing the structure (FIG. 3A) and illustrations of its operation (FIGS. 3B and 3C) of a trap device in a quantum beam irradiation system of an embodiment of the present disclosure.

FIG. 4 is a flowchart showing a typical production method for producing a radionuclide in an embodiment of the present disclosure.

FIG. 5A is an enlarged cross-sectional view of a typical target material container in a quantum beam irradiation system of an embodiment of the present disclosure, and FIGS. 5B and 5C are enlarged cross-sectional views of different typical target material containers, respectively.

FIG. 6A is a schematic illustration of a portion of the structure of a quantum beam irradiation system of an embodiment of the present disclosure in which the axis of rotation is non-parallel to the quantum beam irradiation axis and the quantum beam irradiation axis is directed vertically downward; FIG. 6B is a schematic illustration of the structure of a quantum beam irradiation system of an embodiment of the present disclosure in which the irradiation axis of the quantum beam is included in a plane parallel to the horizontal plane and the axis of rotation is oriented so that it is inclined from the horizontal direction.

FIG. 7 is a schematic diagram of part of the structure of a quantum beam irradiation system of an embodiment of the present disclosure in which the axis of rotation is non-parallel to the irradiation axis of the quantum beam and the irradiation axis of the quantum beam is directed vertically upward.

FIG. 8 is a flowchart illustrating a quantum beam irradiation processing method of the embodiment of the present disclosure.

FIG. 9 is a schematic graph showing the range of processing temperatures that can be employed in the case where a material that can be solid or liquid depending on temperature is employed as a target, in contrast to the case where only a conventional solid target is used, the case where only a liquid target is used, and the case of the quantum beam irradiation system of an embodiment of the present disclosure.

FIGS. 10A and 10B are diagrams showing the specific structure of a container cover used together with the target material container described in connection with FIG. 1.

FIG. 11 is a half sectional view showing the structure of an insulating support that may be added between the spindle and the target material container in the rotational drive mechanism in FIG. 1.

FIG. 12 is a configuration diagram showing the structure of an exhaust pipe assembly that employs a double-tube structure in an embodiment of the present disclosure.

FIGS. 13A-13C illustrate the experimental configurations of Experiment 1 (FIG. 13A), Experiment 3 (FIG. 13B), and Experiment 4 (FIG. 13C), which were conducted for experimental confirmation in an embodiment of the present disclosure.

FIG. 14 is an illustration of the experimental configuration of Experiment 2, which was conducted for experimental confirmation in an embodiment of the present disclosure.

FIG. 15 is a graph showing the temporal dependence of the temperature of the target material container measured in Experiment 3, which was conducted for experimental confirmation in an embodiment of the present embodiment, and the value of the radiation counts output as a voltage by the detection operation directed to the gold foil trap.

FIG. 16 is a graph showing the temperature of the target material container measured in Experiment 4, which was conducted for experimental confirmation in an embodiment of the present disclosure, and the temporal dependence of the radiation counts on the voltage output from the detection operation directed to the activated carbon trap.

FIG. 17 is an illustration of the experimental configuration of Experiments 5 and 6, which were conducted for experimental confirmation in an embodiment of the present disclosure.

FIGS. 18A and 18B are illustrations of the structure of a trap device suitable for the case where Bi particles are generated in an embodiment of the present disclosure (FIG. 18A) and an illustration of its operation (FIG. 18B).

### DETAILED DESCRIPTION

In the following, the structure of a system for quantum beam irradiation, a method for irradiation, and a method for producing radionuclides will be described, together with a target holding device and a target for quantum beam irradiation used for this purpose. Common reference numerals are given to common parts or elements, unless otherwise noted in the description. In addition, each element in each embodiment should not be understood as not being drawn to scale.

### 1. Embodiment

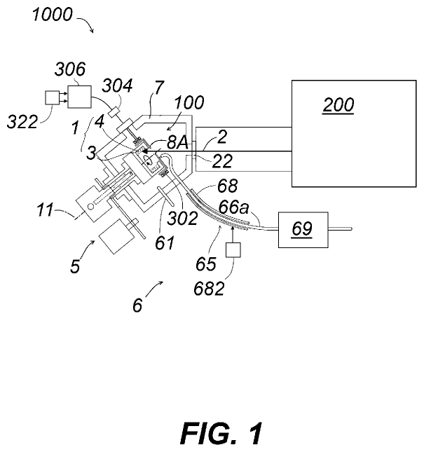

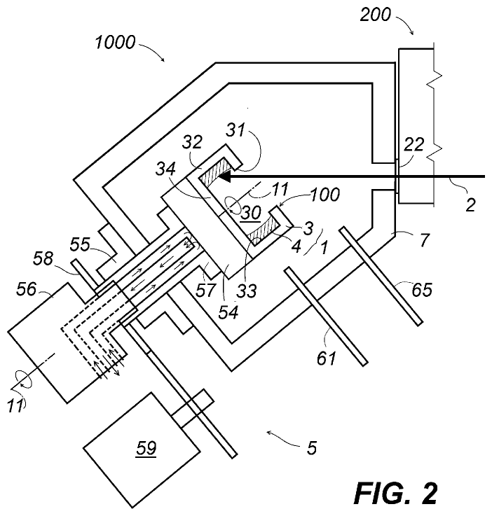

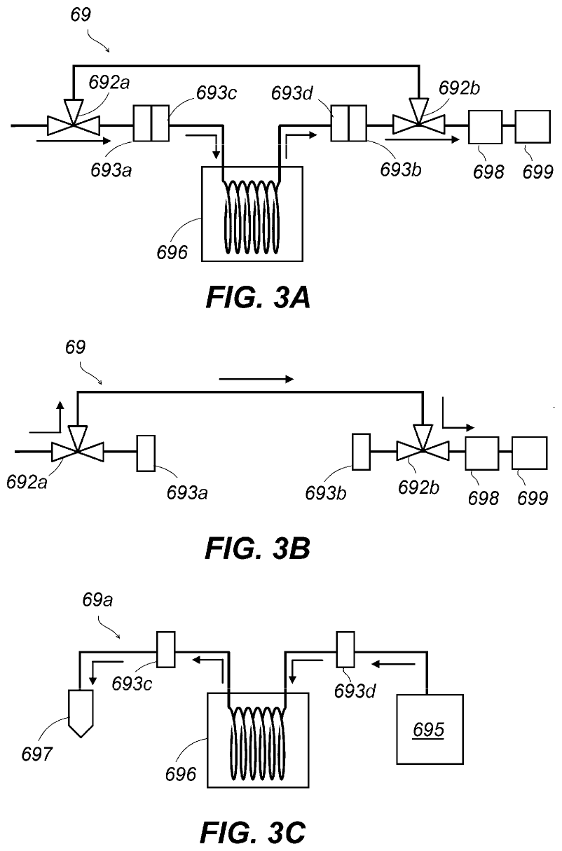

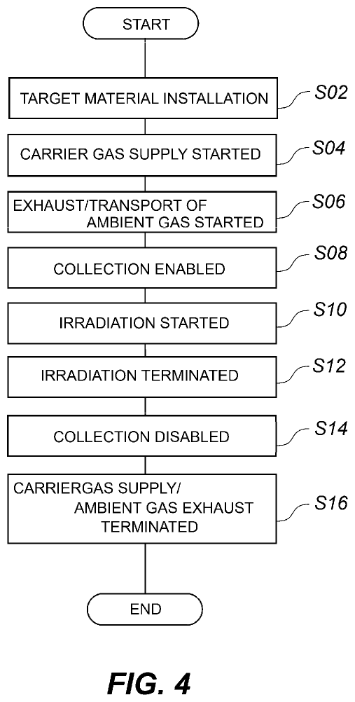

FIG. 1 is a schematic diagram of a quantum beam irradiation system of the present embodiment; FIG. 2 is an enlarged cross-sectional view near the target holding device in the quantum beam irradiation system of the present embodiment; FIGS. 3A-3C are a schematic diagram showing the structure (FIG. 3A) and illustrations of its operation (FIGS. 3B and 3C) of the trap device; and FIG. 4 is a flowchart showing a method of producing radioactive nuclei in the present embodiment. The quantum beam irradiation system 1000 is equipped with a quanta generator 200 and a target holding device 100. The quantum beam 2 from the quantum generator 200 is irradiated to the target material 4 held in the target holding device 100. For the quanta generator 200, a linear accelerator, cyclotron, nuclear reactor, or the like is employed. The quantum beam 2 is not limited in the present embodiment, but is, for example, a beam of electrons, protons, heavy particles (heavy ions), or neutrons and gamma rays that are generated secondarily by the irradiation of charged particles. The output section of the quanta generator 200 is provided with a vacuum window 22 that demarcates the space between the inside of the quanta generator 200, which is evacuated, and the inside of the target chamber 7, allowing the quantum beam 2 to pass through it while properly maintaining airtightness between both sides. The vacuum window 22 can be made of beryllium, for example. The quantum beam irradiation system 1000 is equipped with a radionuclide trap system 6. The radionuclide trap system 6 can be generally divided into a carrier gas supply system 61 and an ambient gas exhaust system 65. The carrier gas supply system 61 is any means for introducing carrier gas into the target chamber 7. The carrier gas is selected according to the target material 4 and the type of radionuclide produced therefrom and is supplied from a cylinder (not shown) into the target chamber 7 through the carrier gas supply system 61 with the flow rate controlled by a regulator (not shown). The ambient gas exhaust system 65 is used to exhaust a gas that comprises the atmosphere of the target material 4 (ambient gas) from the inside of the target chamber 7 and to trap radionuclides from the ambient gas. The ambient gas exhaust system 65 has an exhaust pipe assembly 66a and an exhaust pipe heater 68. The end of the exhaust pipe 66 on the target chamber 7 side in the exhaust pipe assembly 66a is open to vent the containing part 30 of the target material container 3 at a position suitable for exhausting the ambient gas (e.g., container cover 8A). A trap device 69 is connected to the other end of the exhaust pipe 66 in the exhaust pipe assembly 66A. The target chamber 7 is typically fabricated to be airtight except for the carrier gas supply system 61 and the exhaust pipe 66. The target chamber 7 is also pre-treated prior to use, such as a suitable purging process. In typical operation, carrier gas is supplied from the carrier gas supply system 61 during the irradiation step of quantum beam 2 to the target material 4, and ambient gas is exhausted from the target chamber 7 through the ambient gas exhaust system 65. The generated radionuclides can be transported by the ambient gas exhaust system 65 as ambient gas mixed with the carrier gas. However, the amount and concentration of radionuclides contained and transported in the structure of the carrier gas depend on various conditions. Therefore, the ambient gas transported through the ambient gas exhaust system 65 may be only carrier gas, or it may contain a mixture of radionuclides produced in the carrier gas, or it may additionally contain any other material produced as a byproduct.

As shown in detail in FIG. 2, a typical target holding device 100 of the present embodiment has a target material container 3 and a rotational drive mechanism 5. The method of producing radionuclides in the present embodiment can be implemented without this structure of the typical target holding device 100, and the description of the target material container 3 and the rotational drive mechanism 5 is for illustrative purposes only. The target material container 3 has a containing part 30, and the target material 4 is received in the containing part 30 and placed in the target chamber 7. In other words, the containing part 30 in the target material container 3 is used to accommodate the target material 4. The target 1 is the target material 4 mounted in the target material container 3. The target chamber 7 is an enclosure (chamber) for maintaining an environment suitable for the target material 4 to undergo the irradiation process of quantum beam 2. The interior of the target chamber 7, where the irradiation of the target material 4 with quantum beam 2 is carried out, is connected to the output side of the quanta generator 200, and its airtightness can be maintained as needed by the vacuum window 22. The target material container 3, in a typical structure, is rotatable about an axis of rotation 11 in the plane of the paper in FIGS. 1 and 2. The overall shape of the target material container 3, shown in cross section in FIGS. 1 and 2, is any container that can be said to be a container having an opening 31, and is a bottomed cylinder in a non-limiting example, with the axis of rotation 11 corresponding to the axis of rotation 11. The rotational drive mechanism 5 is a mechanism that allows the target material container 3 to rotate with the target material 4 around the axis of rotation 11 and to keep and stop the rotation properly. This rotation causes the target material 4 to be pressed against the inner circumference 33 of the surrounding wall 32 of the target material container 3 from the inside by centrifugal force. For example, while this rotation is maintained, the quantum beam 2 emitted from the quanta generator 200 is irradiated onto the target material 4 in the containing part 30. The opening 31 is for the containing part 30 to be connected to the outside. The outside here refers to the spatial area outside the target material container 3. The opening 31 is used for receiving the target material 4 into the containing part 30, for releasing or taking out the products of nuclear reactions, etc., and also serves as a path for irradiation of the quantum beam 2 to the target material 4. The opening 31 also serves as a path for the carrier gas supplied inside the target chamber 7 from the carrier gas supply system 61 to flow into the containing part 30.

Trap device 69 is equipped to trap radionuclides in ambient gas in the quantum beam irradiation system 1000. In other words, the role of trap device 69 is at least one of removing or collecting the produced radionuclides and their descendant nuclides (if any) from the ambient gas. The structure of the trap device 69, as shown in FIG. 3A, is such that it uses a cold trap 696, a trap system 698, and an exhaust pump 699 to enable collection of radioactive materials by the cold trap 696, while a bypass route can be secured as required by the three-way valves 692a and b and fittings 693a to d. The exhaust pump 699 is used to ensure air flow for trapping and to keep the inside of the target chamber 7 under negative pressure to prevent leakage of radioactive materials to the outside. The trap system 698 prevents leakage of radioactive materials to the outside. The connection configuration in FIG. 3A and the airflow shown by the arrows are in the trap operation of the trap device 69. Fittings 693a and 693c and 693b and 693d are connected to each other, and three-way valves 692a and b are set so that ambient gas from ambient gas exhaust system 65 passes through cold trap 696 between fittings 693c and 693d. In the cold trap 696, the tube is cooled by liquid nitrogen, for example, so that radioactive materials in the ambient gas are trapped in the inner wall of the tube. When the desired radioactive material is trapped in cold trap 696, three-way valves 692a and b are switched to the bypass path respectively, and joints 693a and c are disconnected from each other and from joints 693a and c, respectively. As shown in FIG. 3B, cold trap 696 can be removed. Cold trap 696 is connected to solvent elution system 69a, which is separate from ambient gas exhaust system 65, as shown in FIG. 3C. When an appropriate solvent, such as chloroform, is passed into the cold trap 696 by the pump 695, the radioactive material is collected into the vial 697 together with the solvent.

The quantum beam irradiation system of the present embodiment is typically used to produce secondary particles such as X-rays and neutrons, and is also used to produce radionuclides. In the case of producing radionuclides, the collection of the produced radionuclides can be performed simultaneously with or after the completion of any of the above-mentioned stages, as appropriate. Referring to FIG. 4, a typical production method is described in which radionuclides can be efficiently produced by the quantum beam irradiation system of this embodiment. For reasons of consistency of description, reference will continue to be made to a quantum beam irradiation system 1000 with a structure employing a target material container 3 and a rotational drive mechanism 5. In the process of producing radionuclides by the quantum beam 2, in the installation step S02, the target material 4 for quantum beam irradiation, which is received in the containing part 30 of the target material container 3, is placed inside the target chamber 7. Thereafter, the necessary conditions are set up, for example, gas replacement inside the target chamber 7 (not shown). Then, in step S04, the carrier gas is started to be supplied to the inside of the target chamber 7 through the carrier gas supply system 61. The carrier gas supply continues until step S16, where it is stopped just before the end of the production process. In the next step S06, which starts the ambient gas transport operation, the ambient gas around the target material 4 begins to be exhausted from the exhaust pipe assembly 66a in the ambient gas exhaust system 65. In doing so, the temperature of the exhaust pipe 66 is held, for example, by the exhaust pipe heater 68. In step S08, the trapping device 69 is made ready for trapping. To do so, for example, the three-way valves 692a and b are switched. In this step, conditions are realized such that if radionuclides are subsequently produced, they can be trapped. After the conditions are set, irradiation of the quantum beam 2 to the target material 4 is started (step S10). The irradiation is carried out until a pre-determined point in time, for example, until the required irradiation dose of quantum beam 2 reaches a predetermined value, and then it is terminated (S12). After that, the trap device 69 is finished allowing trapping (S14), and the supply of carrier gas and the exhaust of ambient gas are stopped (S16). It should be noted that the chronological order of the steps described here does not necessarily have to be done as described to implement the method of producing radionuclides in the present embodiment. The step S04, for example, can be performed after the step S06, which starts the transport of ambient gas, for example. In FIG. 4, the transport step includes steps S06-S16, the trapping step includes steps S08-S14, and the irradiation step includes steps S10-S12.

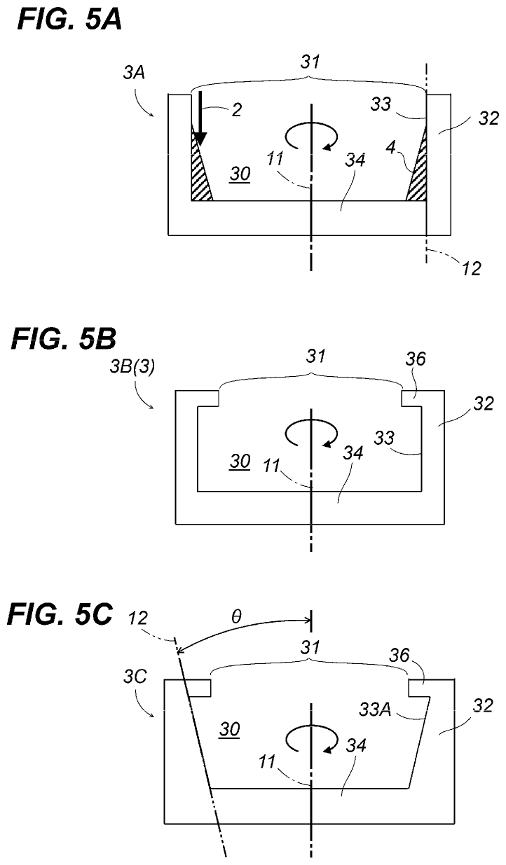

FIGS. 5A to 5C are enlarged cross-sectional views showing the structure of target material containers 3A, 3B, and 3C in a typical configuration that employs a target material container 3 and rotational drive mechanism 5 in the present embodiment. In these figures, the axis of rotation 11 is shown in the vertical direction on the paper. The target material container 3A shown in FIG. 5A has a base 34 and a surrounding wall 32 extending from the base 34, with the base 34 and surrounding wall 32 demarcating at least a portion of the containing part 30 from the outside. The surrounding wall 32 is shaped around the axis of rotation 11. In target material container 3, the axis of rotation 11 passes through the containing part 30 and opening 31. In a typical structure of target material container 3, the axis of rotation 11 also passes through the base 34.

FIGS. 5B and 5C are enlarged cross-sectional views of another typical target material container 3B and 3C, respectively. In FIGS. 5B and 5C, the target material containers 3B and 3C have an inner flange 36 extending from the surrounding wall 32 in addition to the base 34 and the surrounding wall 32. The target material container 3B is similar to the target material container 3 shown in FIGS. 1 and 2. The inner flange 36 extends toward the opening 31, and the opening 31 is surrounded by the inner flange 36.

The specific structure for the target material containers of the present embodiment, including target material containers 3A, 3B, and 3C, is appropriately determined according to the processing conditions, such as the conditions of the material employed for the target material, the rotation conditions, and the irradiation conditions. For example, as illustrated in FIG. 5A, the quantum beam 2 may be kept parallel to the axis of rotation 11 and irradiated to the target material 4. In this case, the opening 31 of the target material container 3A is widened and the inner flange 36 as in target material containers 3B and 3C is not employed. In cases where the orientation of the axis of rotation 11 is angled from the vertical direction or the amount of target material 4 loaded is large, a reduced size opening 31 is employed to ensure retention of the target material 4, and an inner flange 36 is employed accordingly, as in target material containers 3B and 3C.

In the target material container of the present embodiment, the inner surface 10 of the surrounding wall 32 can be formed in a variety of geometries. A typical geometry of the inner surface 10 is a surface of revolution having the axis of rotation 11 as its central axis. A surface of revolution is a shape that overlaps itself when it is rotated about a center axis. To define the surface of revolution, a generatrix 12 typically contained in the same plane as the axis of rotation is utilized. When the generatrix 12 is rotated around the axis of rotation 11, the surface of revolution is the spatial shape that the generatrix 12 sweeps.

Although the axis of rotation 11, around which the target material container 3 is driven to rotate, and the central axis for defining the geometry of the inner surface 33 as a surface of revolution do not generally need to align, they are described as being aligned in the present embodiment for a typical one such that the inner surface 33 is a surface of revolution. Typically, the generatrix 12 is a straight line parallel to the axis of rotation 11. In this case, the inner surface 33 is geometrically part of the side of the cylinder, i.e., a cylindrical surface (FIGS. 5A and 5B). When the generatrix 12 makes a non-zero angle θ with the axis of rotation 11, the inner surface will be part of the side of a cone, i.e., a conical surface, as in the inner surface 33A shown in FIG. 5C. When defining the inner surfaces 33 and 33A by the surface of revolution, the generatrix 12 is preferably parallel to the axis of rotation 11, or the angle θ should be greater than 0° and less than 20°. If the angle θ is too large, there is a risk that the target material 4 will be scattered by centrifugal force. Therefore, the angle θ should be less than 20° at most. In FIG. 5C, the angle θ is defined in such a way that the opening 31 side expands as viewed from the containing part 30, however, the angle can conversely be defined in such a way that the bottom 34 side expands as viewed from the containing part 30. In this case, too, the angle θ should be less than 20° at most. This is because if the angle θ is excessive in this case, it will be difficult to perform irradiation with the quantum beam through opening 31.

As shown in FIG. 2, rotational drive mechanism 5 can typically have an insulating support 54, a rotation feedthrough unit 55, a rotational coupling 56, a spindle 57, a rotational transmission mechanism 58, and a motor 59. The motor 59 is capable of being started, controlled in speed, and stopped in rotation by a control device (not shown in the figure). A typical rotational drive mechanism 5 controls the rotational speed of the target material container 3 so that at least a portion of the target material 4 is repeatedly placed in the irradiation area of the quantum beam 2 while the target material 4 is being pressed by centrifugal force against the inner surface 33 of the surrounding wall 32. The rotational force of the motor 59 rotates the spindle 57 by means of the rotational transmission mechanism 58. The spindle 57 is made hermetically sealed and rotatable by the rotation feedthrough unit 55 and penetrates a part of the target chamber 7, transmitting the rotational force of the motor 59 to the target material container 3 attached to its mounting flange. When the target material container 3 starts to rotate and spin up, the friction between the target material 4 and the inner surface 33 of the surrounding wall 32 causes the target material 4 to rotate as well. After the rotation is stabilized, the rotation speed of the target material 4 is the same as that of the target material container 3 in the case that the target material 4 is solid. In this state, the target material 4 is subjected to centrifugal force corresponding to the rotational motion, and when the rotational speed is sufficiently high, the target material 4 is pressed toward the target material container 3. The inner surface 33, which prevents the target material 4 from popping out, exerts a force in reaction to that pushing force, which becomes the centripetal force acting on the target material 4. As a result, the target material 4 is held stable by the target material container 3. The rotary coupling 56 can also be responsible for exchanging refrigerant between the spindle 57, target material container 3, and target material 4 with an external refrigerant temperature control device and circulation drive device (both not shown), while allowing the rotary motion of the spindle 57, target material container 3, and target material 4.

The actual dynamic behavior of the target material 4 can also be complex, depending on conditions such as the material of the target material 4, the specific shape and orientation of the target material container 3, and the speed of rotation. For example, in addition to the circumferential frictional force between the target material 4 and the inner surface 33 during spin-up and the centrifugal force outward in the radial direction due to rotation, gravity also acts on the target material 4. Here, the frictional and centrifugal forces are orthogonal to each other, while gravity is determined by the orientation of alignment of the target material container 3. However, when the rotational speed of the target material container 3 becomes sufficiently large to achieve steady-state rotation, the centrifugal force becomes dominant and the positioning of the target material 4 can be sufficiently stabilized by the action of pressing it against the inner surface 33. Whether the physical state of the target material 4 is solid, liquid, or a mixture of solid and liquid, it is possible to maintain the circular motion of the target material 4 without causing it to fall out of the rotating target material container 3 if the target material container is properly designed with the appropriate orientation and rotation speed. There is no obstacle to keep this stable circular motion while continuing the irradiation of quantum beam 2. When the target material 4 is allowed to perform the circular motion while being pressed by centrifugal force against the inner surface 33, the target material 4 is repeatedly placed in the irradiation area of the quantum beam 2 at each instant, even if only a portion of the target material 4 is irradiated at that instant. When the target material 4 contains a liquid part with fluidity, each part of the liquid can generate, in addition to the above-mentioned frictional force, centrifugal force, and gravity, a convection flow due to the decrease in density caused by heating. Since this flow is accompanied by the transfer of heat in the target material 4, together with the intermittent irradiation of quantum beam 2 to the target material 4, the rotational motion acts to suppress the temperature rise of the target material 4.

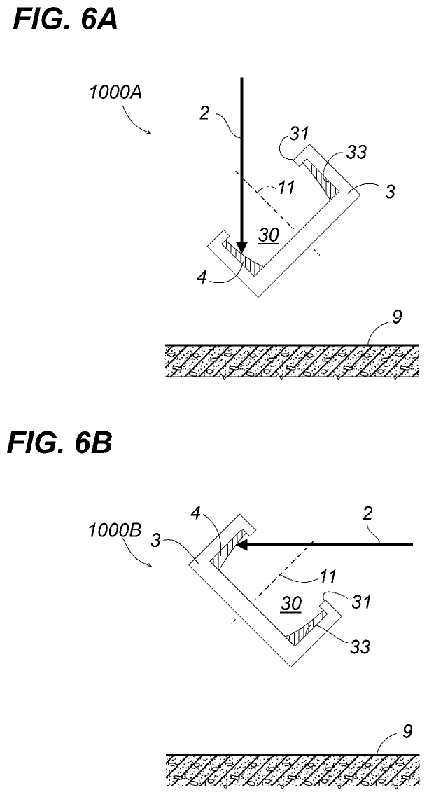

As shown in FIGS. 1 and 2, in a typical configuration of the target holding device 100 employing a target material container 3 and a rotational drive mechanism 5, the arrangement relative to the quantum beam is determined so that the axis of rotation 11 is non-parallel to the irradiation axis of quantum beam 2. The irradiation axis of the quantum beam 2 can be a principal direction that characterizes the orientation of the quantum beam 2 for aiming when irradiating a target to be processed. Thus, the irradiation axis of quantum beam 2 can include the direction of the beam flux when quantum beam 2 is a collimated beam, the average or weighted direction of the beam flux if quantum beam 2 is a convergent or divergent beam, the direction of maximum intensity, etc. The term “non-parallel” includes not only the relationship in which the axis of rotation 11 is in the same plane as the irradiation axis and not parallel, but also arrangements in which they are not in the same plane and are in a twisted position. FIG. 6A is a schematic diagram showing part of the structure of the quantum beam irradiation system 1000A when the axis of rotation 11 is non-parallel to the irradiation axis of quantum beam 2 in the present embodiment. In quantum beam irradiation system 1000A, the irradiation axis of the quantum beam 2 is oriented vertically downward, and the axis of rotation 11 is inclined from the vertical direction. The horizontal plane is typically defined by a horizontal floor 9 or the like. The irradiation process using quantum beams with the irradiation axis facing vertically downward is disclosed in Patent Document 3.

When a quantum beam irradiation system is actually designed, the irradiation axis of the quantum beam 2 is often made to be included in a plane (horizontal plane) such that the vertical direction is normal to it, in addition to a structure that is oriented vertically downwards. The quantum beam irradiation system of the present embodiment can also be adapted to horizontally oriented irradiation, and in that case, the arrangement of the axis of rotation 11 should also be adjusted. In such a case, the axis of rotation 11 is arranged to be inclined from the horizontal direction, so that the target material 4, which is pressed against the inner surface 33 by the centrifugal force of the rotation of the target material container 3, is irradiated with quantum beams 2 through the opening 31. FIG. 6B is a schematic illustration of the structure of a quantum beam irradiation system 1000B of the present embodiment in which the irradiation axis of the quantum beam 2 is included in a plane parallel to the horizontal plane 9, and the axis of rotation 11 is oriented so that it is inclined from the horizontal direction. If the target material 4 can be pressed against the inner surface 33 by centrifugal force with this arrangement, it will be easier to irradiate quantum beams 2 through the opening 31, even if the irradiation axis of the quantum beam 2 is made to have an irradiation axis in a plane parallel to the horizontal plane.

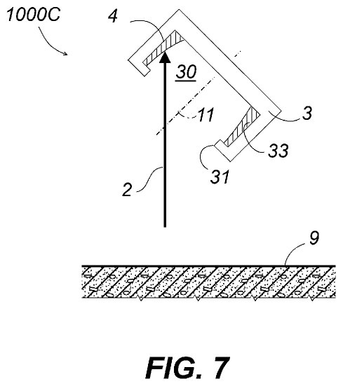

The direction of irradiation of quantum beam 2 is not particularly limited in the present embodiment. As long as the target material 4 does not drop out of the target material container 3, the irradiation direction of quantum beam 2 irradiating the target material 4 is freely chosen. FIG. 7 is a schematic diagram showing part of the configuration of the quantum beam irradiation system 1000C when the axis of rotation 11 is non-parallel to the irradiation axis of the quantum beam 2 in the present embodiment. In the quantum beam irradiation system 1000C, irradiation with the quantum beam 2 directed vertically upward is performed by employing a rotation speed at which the target material 4 does not drop out of the target material container 3.

The specific structure of the target material container 3 is described below. The material of the target material container 3 is selected in consideration of radiation resistance and chemical aspects to meet the requirements for the process of irradiation with a quantum beam, for example, a material that does not show chemical reactivity to the target material 4 or products therefrom. Mechanical aspects are also considered in the specific structure of the target material container 3. Since the target material container 3 is used in a rotating manner, the strength of the target material container 3 to withstand rotation is considered, taking into account the centrifugal force received from the target material 4, and the machinability for fabrication is also considered. Furthermore, when the quantum beam 2 is charged or the target material container 3 is heated by induction, the electrical aspect of the target material container 3 is also taken into account, and the typical material of the target material container 3 is selected from materials that exhibit electrical conductivity. In other words, the typical material of the target material container 3 is selected from materials that, in addition to conductivity, have sufficient heat resistance and strength at the temperature at which they are used, and can be processed for manufacturing themselves. One example is graphite (carbon) material. It is advantageous that the target material container 3 is utilized in a rotating manner, as this alleviates at least one of the issues that may be problematic in the irradiation process of a quantum beam. The target material container 3 may itself be heated to adjust the properties of the target material 4 (solid-liquid phase). In this case, the suitability for heating is an additional consideration when selecting the material of the target material container 3.

If the ambient of the target material 4 is isolated from the outside by the target chamber 7, the choice of material for the target material container 3 may be influenced. The target chamber 7 can serve as a shield from the outside. Therefore, it is preferable to make the target chamber 7 have a sealed structure that does not allow the target material 4 or, in some cases, the material produced by the irradiation of quantum beam 2 to leak to the outside. This is to prepare for the case that some failure occurs in the part containing the rotating target material container 3, for example, if the target material container 3 is damaged. Since this performance that can limit external effects is only in contact with the target material in an emergency, it can be achieved even if the target chamber 7 does not have the same safety and strength as a pressure vessel. Therefore, if the target chamber 7 is employed, only the chemical aspects of radiation tolerance and corrosion resistance with the target material container 3 need to be considered for the target material container 3. On the other hand, in selecting the material for the target chamber 7, only minimal requirements in terms of reactivity with the target material need to be considered, which would be different from the requirements for the target material container 3. Thus, if the requirements for the target chamber 7 and target material container 3 are made independent, the technical requirements for properties such as strength of the target material container 3 material are not so high, which allows a wide range of materials to be selected for each material.

In the case where a radionuclide is going to be produced by irradiation with the quantum beam 2, if the radionuclide can be transported by gas and the ambient of the target material 4 is isolated from the outside due to the target chamber 7, it is possible to produce the radionuclide efficiently by using gas (carrier gas) introduced into the target chamber 7. It should be noted that this high production efficiency can be achieved in a configuration where the target material container 3 operated with rotation is not adopted.

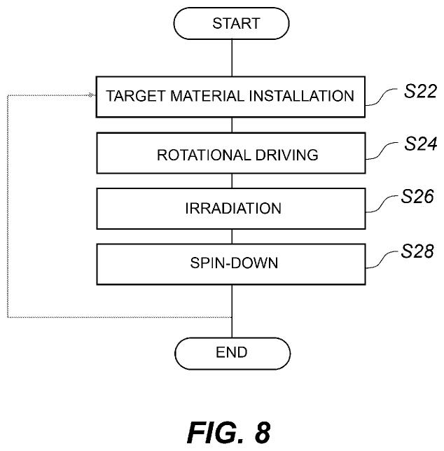

Next, a series of irradiation processing methods using the quantum beam irradiation system of the present embodiment will be described. FIG. 8 is a flowchart illustrating the quantum beam irradiation processing method. Upon starting the process, in the installation step S22, the target material container 3, which is receiving the target material 4 for quantum beam irradiation in the containing part 30, is placed in the interior of the target chamber 7. Thereafter, the required conditions are set up, for example, gas displacement inside the target chamber 7. In the rotational drive step S24, the target material container 3 is spun up and held at the desired rotational speed. As the target material container 3 spins, friction acts on the target material 4 to rotate at the same rotational speed if the target material 4 is solid, and it begins to rotate above a certain acceleration even if the target material 4 is liquid, until the target material container 3 and the target material 4 reach the same rotational speed. In the irradiation step S26, the target material container 3 is irradiated with the quantum beam 2 while maintaining the rotation of the target material container 3. Depending on the irradiation conditions and the type of target material 4, even if the target material 4 is initially solid, there is a possibility that it may melt. In this case, there may be a difference in rotational speed between the target material container 3 and the target material 4. However, the relative velocity between the target material container 3 and the target material 4 is insignificant, and the target material 4 is held stable by being pressed against the inner surface 33 of the surrounding wall 32 of the target material container 3 by the centrifugal force acting on it. After the irradiation step S26, the irradiation is stopped and the spin-down step S28 is performed to stop the rotation of the target material container 3. If spin-down cannot be performed immediately because the target material 4 has melted or for some other reason, an auxiliary step (not shown) is also employed, such as maintaining the rotation for a predetermined period and waiting for cooling, if necessary. Once the spin-down is completed, the process is terminated. In addition to what is described here, any other processing processes may be employed in this series of processes that conform to the quantum beam irradiation system of the present embodiment, the installation step S22, the rotational drive step S24, and the irradiation step S26. After the completion of the spin-down step S28, the irradiation process of the quantum beam 2 can be continued back to the installation step S22 and rotational drive step S24 as needed, as shown by the dotted line in FIG. 8. The quantum beam irradiation system of the present embodiment is typically used to generate secondary particles such as X-rays and neutrons. When the quantum beam irradiation system of the present embodiment is utilized for production of radioisotopes (RIs), the collection of products can be performed simultaneously with or after any of the steps described above, as appropriate. For example, by combining the method of quantum beam irradiation using a rotational drive described in FIG. 8 with the method of producing radionuclides shown in FIG. 4, the radionuclide can be produced efficiently. In FIG. 8, the irradiation step corresponds to step S26, and the rotational drive step corresponds to steps S24-S28.

The specific irradiation procedure related to the rotation operation can be performed as exemplified in the case where Bi is the target material 4, as follows. Reference is made to FIG. 4 and FIG. 8 as appropriate. First, Bi pellets (or Bi blocks), which will be the target material 4, are loaded into the target container 3 (FIG. 4, S02; FIG. 8, S22). Next, the inside of the target chamber 7 is evacuated and replaced with a He atmosphere, and then the target material container 3 is heated to 300° C. This temperature is set to exceed the melting point of Bi (271° C.) when the target material 4 is melted Bi. Next, the target material container 3 is driven in rotation with the melted Bi (FIG. 8, S24). When the rotation speed exceeds a certain value (e.g., about 500 rpm for a target material container 3 with an inner diameter of 60 mm), the melted Bi begins to spread on the inner surface 33 of the surrounding wall 32. When the target material container 3 is turned up to a sufficient rotational speed (e.g., 800 rpm), the molten Bi is allowed to reach the upper part of the inner surface 33 surrounding wall 32. The subsequent steps related to irradiation and trapping (FIG. 4, S06-S16; FIG. 8, S26) can now be performed. The rotation of the target material container 3 is then stopped (FIG. 8, S28). If the rotation is stopped while the Bi is still liquid, the Bi may splash around and a small amount of Bi may be scattered in the chamber. To prevent this, the rotation is stopped after confirming that the target material container 3 is below the temperature (271° C.), which was set as a guideline for melting the Bi, and then the rotation is stopped.

Next, we explain the technical effects of rotation in the quantum beam irradiation system and irradiation processing method in which the rotational motion is employed in the present embodiment. Irradiating the target material 4 with the quantum beam 2 while rotating the target material container 3 has various technical effects in contrast to conventional methods that employ only solid targets or only liquid targets as targets. First, the irradiation area of the quantum beam 2 can be increased and the heat load can be dispersed. Second, excessive temperature rise of the target material 4 can be prevented. This is because, when focusing on a part of the target material 4, that part is intermittently irradiated, alternating between being irradiated and not being irradiated.

Furthermore, the quantum beam irradiation system and irradiation processing method of the present embodiment, which can combine temperature control and rotation, can achieve a higher degree of practicality. As mentioned above, the preparation of thin Bi target material suitable for irradiation in the form of a thin film on the spot can be completed simply by placing Bi pellets in the target material container 3, heating, and rotating the container. In the present embodiment of quantum beam irradiation system and irradiation processing method, a number of high practicalities can be performed by combining temperature control and rotation. First, the target material can be kept at a temperature at which At is collected during beam irradiation. Second, the target material can be kept at the temperature to collect At after beam irradiation. These are practicalities in terms of beam irradiation and collection. Third, the target material suitable for irradiation can be easily prepared.

The target holding device of the present disclosure can be applied to target materials and high heat load conditions that have been difficult to achieve with conventional methods, such as when solid targets have poor heat resistance due to their low melting point, when liquid targets cause corrosion problems, or when preheating is difficult due to their high melting point.

Furthermore, for solid targets, defects caused by radiation degradation or thermal stress may cause the target material to drop out or melt. With the target holding device of the present disclosure, the target material remains in the containing part without dropping out even if those defects occur. Depending on the material, the occurrence of defects in the target material may inhibit heat conduction, resulting in a part of the target material becoming hot and melting. However, even in such a situation, the target holding device of the present disclosure, in which the target material container is revolving, allows the melted part of the target material to stay in the containing part, and furthermore, it can be expected that the melted part will fill the defects generated and the defects will be repaired. The target material containers of the present disclosure also provide the advantage of being less prone to erosion by the target material and the products of quantum beam irradiation. These advantages enable the target holding device of the present disclosure to irradiate quantum beams 2 with increased beam intensity, thereby increasing the efficiency of producing, for example, radionuclides.

In the quantum beam irradiation system in the present embodiment, any material that is either solid, liquid, or a mixture of solid and liquid can be employed for the target material. Among these solids, not only bulk materials and nuggets with a certain shape, but also pellets or powders that are treated collectively and do not have a specific shape.

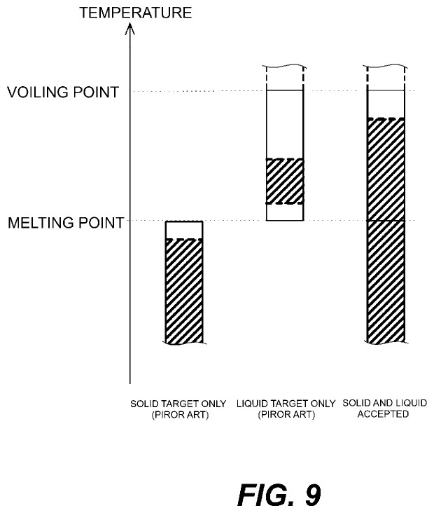

FIG. 9 is a graph showing schematically the range of processing temperatures that can be employed in the case where a material that can take solid and liquid forms depending on temperature is employed as a target, contrasting the conventional case where only solid targets are used, the case where only liquid targets are used, and the case where the present embodiment of the quantum beam irradiation system is used. Shown in comparison here are the cases where the same material is used as the target material for the quantum beam irradiation treatment of the target material, when only solid targets are used, when only liquid targets are used, and when both solid and liquid targets are accepted. In FIG. 9, the temperature range in which the target material can maintain its physical state under each condition is indicated by an area of solid lines, and the temperature range that can be adopted with a margin in the actual treatment is indicated by hatching. Here, the case where a metallic material is employed as a typical example of target material is described. In the conventional irradiation method, when the material is treated as a solid target, the temperature of the target material during the treatment is controlled to allow a certain margin to the melting point, that is, to be lower than the melting point. Thus, in the conventional irradiation method, if the intensity of a quantum beam is strong enough to treat the target material as a solid target, it becomes necessary to manage the temperature so that it does not exceed the melting point during the period of irradiation treatment. From a practical standpoint, the maximum temperature reached during the treatment is managed to be lower than the melting point by a certain margin. For this reason, the conventional irradiation method requires a mechanism to limit the intensity of quantum beams or to cool the target material. On the other hand, when the target material is treated as a liquid target in the conventional irradiation method, it must be able to remain in a liquid state at least for the duration of irradiation. Therefore, preheating before irradiation and other treatments to keep the temperature are necessary. In this case, too, a certain margin must be considered from a practical standpoint, and the minimum temperature must be kept higher than the melting point by a margin. In the case of liquid targets, the temperature of the target material may exceed the boiling point when irradiated with a high intensity quantum beam. Therefore, the upper temperature limit must also be kept well above the boiling point. In other words, even when the target material is used as a liquid target, the conventional irradiation method limits the intensity of the quantum beam or requires a mechanism for cooling or temperature control. Thus, the conventional irradiation method requires separate equipment structures and handling for the solid target and the liquid target, and separate preparation for the irradiation process is also necessary.

In contrast, in the quantum beam irradiation system in the present embodiment, it is possible to perform irradiation processing from a low temperature below the melting point for the material employed for the target material to a high temperature above the melting point without major changes in the structure of the equipment or processing procedures. On the high temperature side, a wide range of temperatures up to the immediate boiling point of the material can be treated. In other words, as long as the target material is kept pressed against the inner surface of the target material container by centrifugal force, no major changes are required in the irradiation process, whether the temperature of the target material is lower or higher than the melting point. Even if the target material reaches a high temperature near its boiling point, it is pressed against the inner surface by centrifugal force, and rotation acts on the liquid to promote convection, which is expected to have a sufficient cooling effect. The quantum beam irradiation system in the present embodiment is also resistant to corrosion and can keep the target material container at a low temperature. Furthermore, since the relative velocity between the target material and target material container is almost zero, erosion is expected to be very small. The target material container is also expected to have a very low erosion rate. For these reasons, the processing temperature can be set closer to the boiling point than in the conventional irradiation process for liquid targets. Furthermore, even if the treatment is started from the target material in a solid state, for example, and a temperature increase over time due to the treatment is inevitable, the irradiation treatment can be continued without paying much attention to the state change due to melting. Thus, in the irradiation process in the present embodiment quantum beam irradiation system, there is less need to consider factors such as precise temperature control and cooling (for solid targets), preheating, and temperature maintenance (for liquid targets), which were necessary in the past to consider the possibility of melting. The present embodiment of a target holding device, system, target, and method for quantum beam irradiation with such a wide tolerance for the target material greatly enhances the practicality of quantum beam irradiation processing.

It should be noted that when adopting a processing temperature close to the boiling point even when the target material is a metal, a suitable structure is one in which the target chamber is responsible for isolation from the outside and the target material container is responsible for contact with the target material. When a target chamber is used, the main requirements for the target material container are reduced to resistance to corrosion and radiation at high temperatures. The target chamber also does not come in contact with the target material, so it can be kept at a low temperature. Therefore, the need to require pressure resistance for the target chamber at high temperatures with reduced material strength is decreased.

Extending the advantages described above in relation to FIG. 9 to a typical target, bismuth (²⁰⁹Bi, melting point 271.5° C., boiling point 1564° C.), the quantum beam irradiation system in the present embodiment can also perform irradiation temperatures that reach 1000° C. after melting. For example, it is sufficiently realistic to adopt a structure in which the target material container is made of graphite and the target chamber 7 is a water-cooled aluminum alloy. On the other hand, when a conventional liquid metal is circulated and employed as a liquid target, a temperature that reaches 1000° C. is difficult to adopt as an irradiation temperature. This is because even if stainless steel is employed for the piping for circulation, etc., it cannot withstand temperatures as high as 1000° C., and in addition, when pressurized, high-temperature Bi circulates in the piping, erosion problems are inevitable.

### 2. Variations

Now, we will explain some of the preferred variations in the present embodiment. In embodying the contents of the present embodiment of the present disclosure, various variations can be made to improve the efficiency of the irradiation processing procedure shown in FIG. 8. For example, it is useful to shorten the stopping time of the quantum beam irradiation system 1000 by setting the target material 4 in the target material container 3 and replacing that target 1 as a unit. As clearly shown in FIGS. 1 and 2, the target 1 is the target material container 3 with the target material 4 mounted on it.

Even if the target material container 3 is continuously irradiated with the quantum beam 2 at a high power, an excessive temperature rise is unlikely to occur, as described above. However, if heat dissipation is still required to cool the target material 4, target material container 3, etc., it is preferable to provide a heat dissipation mechanism. As shown in FIG. 2, it is preferable for the target material container 3 to have the outer surface of its base 34 in thermal contact with a heat transfer member shaped such that it extends along the axis of rotation. This heat transfer member can be made of a variety of materials that are compatible with the required heat transfer performance. In FIG. 2, a spindle 57 is used as this heat transfer member. The spindle 57 is coaxially disposed on the axis of rotation 11 and rotates itself around the axis of rotation 11 by the driving force from the motor 59 while holding the target material container 3 with the bottom 34 attached. The spindle 57 has a multi-pipe structure, as shown in FIG. 2, which can introduce a refrigerant such as water from the outside and maintain the rotation while conducting heat away from the target material container 3, which is an example of a preferred heat transfer member. Any heat-transfer member that can be expected to conduct sufficient heat can be employed freely, depending on the operating conditions, such as the heat flow rate and temperature required for the target material container 3. For example, a metallic heat transfer member can be used. Note that a heat-transfer member is not always necessary. For example, it is also useful to cool the target chamber 7 by thermal conduction or to fill the target chamber 7 with cooling gas to dissipate heat by thermal conduction and convection of the gas. The target chamber 7 can be cooled by heat conduction. Cooling of the target material container 3 through the rotary coupling 56 is not necessarily required if heat dissipation by infrared radiation can be expected for the target chamber 7 and cooling by such radiation is sufficient. The insulating support 54 placed between the target material container 3 and the spindle 57 is described later.

In the description of the present embodiment, FIGS. 1, 2, 6A, 6B, and 7 show an example of a configuration in which the axis of rotation 11 is arranged to form an angle with respect to the irradiation axis of the quantum beam 2 when irradiating the target material 4, but in the present embodiment, such a structure is not necessarily the only configuration included. The advantages of the present embodiment described for the quantum beam irradiation system 1000 can be demonstrated if the target material container 3 can be stabilized by centrifugal force acting on the target material 4 while irradiating with the quantum beam 2 by adjusting the rotation speed of the target material container 3 and the size of the opening for irradiation 31. In FIG. 5A above, the irradiation axis of the quantum beam 2 is parallel to the axis of rotation 11. By adjusting the rotation speed of the target material container 3 appropriately, various materials can be employed for the target material 4 in the quantum beam 2 irradiation process.

Also, although the inner surfaces 33 and 33A have been described so far in the description, where the generatrix 12 (FIG. 5A, 5C) is a straight line and the inner surfaces are cylindrical or conical surfaces, these are only examples of the present embodiment. Although the inner surface 33 is shown, it is also desirable to provide a structure that increases the frictional force against the target material 4 or helps to hold the target material 4 in the inner surface where the centripetal force, which is a reaction against the centrifugal force, acts against the target material 4 in the target material container 3. Preferred examples of this structure include surface features such as grooves, protrusions, and the like. A structure in which the generatrix characterizing the shape of the inner surface is a curved line is another example of a preferred structure that is expected to act to shape the target material 4 in rotational motion into the intended shape.

### 3. Improved Yield in the Production of Radionuclides

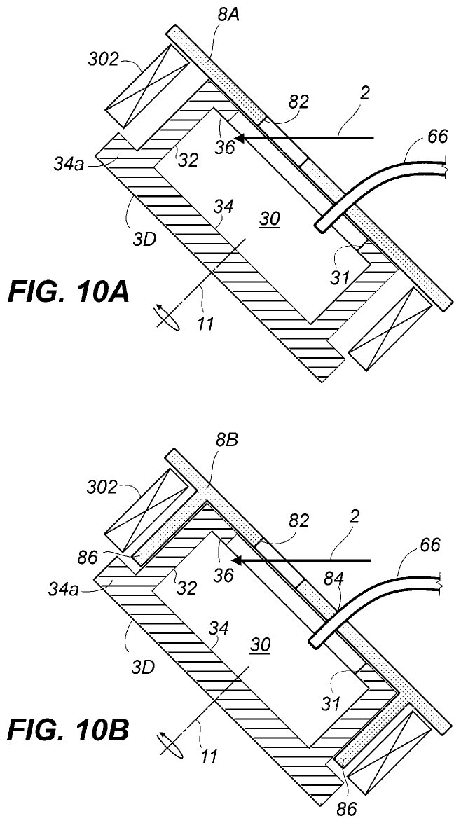

Next, a technique for further improving the yield in the production of radionuclides in the present embodiment will be described. The yield refers to the amount of radionuclides that are trapped in a usable state relative to the amount of radionuclides produced in the nuclear reaction. FIGS. 10A and 10B show the specific structure of the container cover used with the target material container described in connection with FIG. 1. The target material container 3D has a bottom 34, a surrounding wall 32 extending from the bottom 34, and an inner flange 36 extending from the surrounding wall 32. Target material container 3D is similar to target material container 3B (FIG. 5B) except that the base 34 has a peripheral flange 34a extending outward from the peripheral wall 32, and is used in the same manner as target material containers 3, 3A, 3B, 3C (FIGS. 5A-5C) in FIG. 1. Target material container 3D is fabricated, for example, by machining a graphite block.

At locations surrounding the outer surface of the surrounding wall 32 of the target material container 3D, an induction heating coil (container heater) 302 made to form a ring is installed so that its central axis is aligned with the axis of rotation of the target material container 3D. As shown in FIG. 1, the induction heating coil 302 is electrically connected to a high-frequency power supply 306 via a matching device 304, and a magnetic field that generates an induced current in the target material container 3D is generated by the induction heating coil 302. The high-frequency power supply 306 can adjust its output under the control of the container heater controller 322. This allows the target material container 3D to be easily controlled to the required temperature even when it is being driven to rotate.

When the target material container 3D is used to irradiate the target material (not shown in FIGS. 10A and 10B) with the quantum beam 2 and the radionuclides produced in the irradiation are transported by ambient gas, it is preferable to install a container cover 8A (FIG. 10A). The container cover 8A is such that it generally covers the opening 31 of the target material container 3D, except for the opening 82 for irradiation of the quantum beam 2. The container cover 8A is typically separated from the target material container 3D by a small gap and does not rotate when the target material container 3D is rotated. In one example configuration, the container cover 8A is attached to the induction heating coil 302. During irradiation of the quantum beam 2, the system can be operated as described in connection with FIGS. 1, 2, and 4, so that carrier gas is introduced through the carrier gas supply system 61 and the ambient gas is vented through the exhaust pipe 66. In doing so, radionuclides produced in the target material 4 due to the quantum beam 2 can be released into the atmosphere inside the containing part 30. If the radionuclides to be produced are volatile or under such conditions, the ambient gas from the containing part 30 side of the container cover 8A should be directed to the exhaust pipe 66 so that the concentration of the radionuclides in the ambient gas is increased. Since the container cover 8A is fabricated to generally cover the opening 31, i.e., to provide an opening for irradiation 82 of the minimum size required so as not to interfere with irradiation of the quantum beam 2 to the target material container 4, the structure using the container cover 8A is useful to trap radionuclides with a high yield. The opening for irradiation 82 is also the main path for the carrier gas supplied inside the target chamber 7 to enter the containing part 30. The container cover 8A should be made of a material that is highly heat resistant, does not contaminate the produced radionuclides, and does not adsorb radionuclides easily (e.g., quartz glass). FIG. 10B shows another type of container cover 8B in the present embodiment. Like the container cover 8A (FIG. 10A), the container cover 8B generally covers the opening 31 and has a side cover section 86 that extends between the induction heating coil 302 and the surrounding wall 32 to further suppress leakage of ambient gas from the target material container 3D. If the container cover 8B is made of a non-conductive material, it does not particularly interfere with the heating of the target material container 3D by the induction heating coil 302. In addition to the structure shown in FIGS. 10A and 10B, where the exhaust pipe 66 reaches directly into the containing part 30, the container covers 8A and 8B can also be configured such that, for example, nozzles (not shown) are made of the same material on the container covers 8A and 8B and the exhaust pipe 66 is connected thereto.

In order to trap the produced radionuclides with a high yield, it is also useful to properly control the temperature of the target material 4 itself, in which the target radionuclides of interest are produced inside it, and the temperature of each part that comes in contact with the ambient gas containing the radionuclides. In addition to the method described above with reference to FIG. 2, in which the temperature rise of the target material 4 is suppressed by heat dissipation through the spindle 57 or gas, it is also useful in the present embodiment to heat the target material 4 or to intentionally suppress heat dissipation. The temperature of the target material 4 can be adjusted by controlling the heating of the target material containers 3-3D (collectively referred to as “target material container 3, etc.”) by the induction heating coil 302 as well as the beam intensity of the quantum beam 2. For this purpose, it is useful to control the output from the induction heating coil 302 using the container heater controller 322 while measuring the surface temperature of the target material container 3, etc., using, for example, a radiation thermometer (not shown). The ambient gas exhaust system 65, including the exhaust pipe 66 with which the ambient gas comes in contact, can be equipped with an exhaust pipe heater 68, as depicted in FIG. 1, to prevent adsorption of the target radionuclide inside the exhaust pipe 66. The temperature of the target material 4 and the ambient gas can be adjusted accordingly, depending on the type of quantum beam, its intensity, and the specific mode of nuclear reaction.

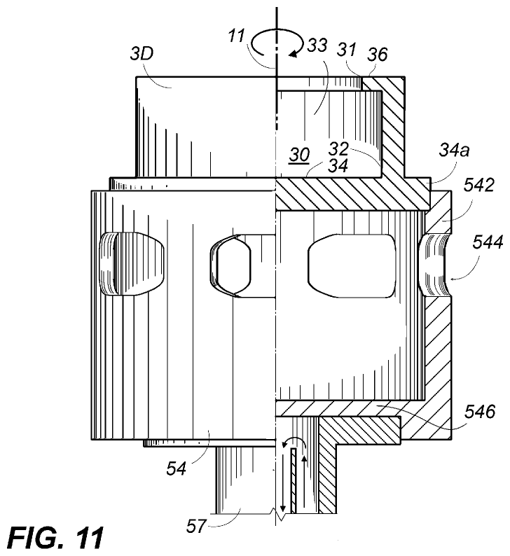

If heat conduction through the rotational drive mechanism that supports the target material container 3 or the like in a rotatable manner causes problems, it is also desirable in the present embodiment to employ a rotational drive mechanism that employs a structure that interferes with heat conduction (heat transfer adjusting structure). FIG. 11 is a half sectional view of the structure of the insulating support 54 that can be added between the spindle 57 and the target material container 3D in the rotational drive mechanism in FIG. 1. The peripheral flange 34a of the base 34 of the target material container 3D is fitted into the surrounding wall 542 of the insulating support 54, and the insulating support 54 is attached to the spindle 57 so that the target material container 3D, the insulating support 54, and the spindle 57 are driven rotationally as one unit. The target material container 3D is heated by the induction heating coil 302 shown in FIG. 1 and FIG. 10A. Depending on its temperature, it may be difficult to keep the temperature of the target material 4 contained in the target material container 3D, or excessive heat might be transferred to the spindle 57 of the rotary mechanism 5. In such cases, it is preferable to provide any structure that acts as a heat transfer adjusting structure at one of the locations in the insulating support 54 so that heat from the target material container 3D is less likely to be transferred to the base 546 of the insulating support 54. In the insulating support 54 of FIG. 11, heat transfer regulation holes 544 are provided in the surrounding wall 542 to increase the heat resistance to the base 546. The insulating support 54 can be made of any material depending on the conditions of use. For example, by selecting a titanium alloy as the material using the AM (Additive Manufacturing) method, an insulating support 54 can be manufactured that exhibits a certain degree of heat resistance and has the required or preferred shape. In addition to the heat transfer regulation holes 544, structures that function as heat transfer adjusting structures can be employed as needed to reduce heat transfer and promote heat dissipation. For example, it is preferable to employ an insulation structure in which a substance with low thermal conductivity is inserted in the middle of the surrounding wall 542 or in the mating portion holding the periphery of the bottom 34 of the target material container 3D, or to provide a thin-walled structure or a skeleton structure with increased surface area or a heat radiation fin structure, and a composite structure combining these structures is also a composite structure combining them is also preferable.

The insulating support 54 shown in FIG. 11 can be further modified to have other structures. Instead of the structure of simply forming heat transfer regulation holes 544 in the surrounding wall 542, the stiffness and heat transfer performance can be adjusted by employing any shape that takes advantage of the superior shape construction techniques of the AM method. For example, the amount of heat transfer can be adjusted by employing a lattice structure (not shown) at the location of the heat transfer regulation holes 544 and adjusting the thickness of each section of the lattice. The material of the insulating support 54 should be Ti-6Al-4V, a titanium alloy. This material is a reduced-activation material and has a lower thermal conductivity than SUS 304, a common vacuum material. Its corrosion resistance is better than that of aluminum, making it a suitable material for insulating support 54.

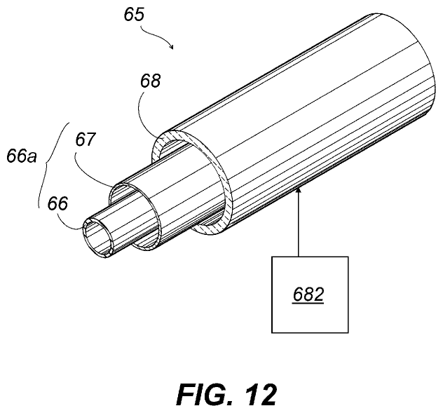

Temperature control of the ambient gas exhaust system 65 for the ambient gas and its transport includes heating by the exhaust pipe heater 68 shown in FIG. 1, which can be equipped with an exhaust pipe heater controller 682 to power and control the heating. Any type of heater can be employed for the exhaust pipe heater 68 to heat the exhaust pipe. Heating the exhaust pipe assembly 66a with the exhaust pipe heater 68 can maintain the ambient gas being transported at the proper temperature and deter problems such as unintentional adsorption of the desired product inside the exhaust pipe 66 of the exhaust pipe assembly 66a. The exhaust pipe assembly 66a is made of a material that is appropriate for the target product and the nature of the carrier gas. The exhaust pipe assembly 66a has a double-tube structure that combines the exhaust pipe 66, which is itself made of a material that may not transfer heat easily, with a heat transfer sheath 67 that covers the surrounding area. FIG. 12 shows the structure of the exhaust pipe assembly 66a, which employs a double-tube structure in the present embodiment. The heat transfer sheath 67 is preferably a tube made of copper or other metal. In the exhaust pipe assembly 66a that employs a double-tube structure, it is the heat transfer sheath 67 that is directly heated by the exhaust pipe heater 68 controlled by the exhaust pipe heater controller 682, and the exhaust pipe 66 is indirectly heated through the heat transfer sheath 67. This performs spatially uniform heating. Therefore, the exhaust pipe 66 can be made of a material that can handle direct contact with ambient gas, and the heat transfer sheath 67 can be made to function to suppress changes in temperature depending on the position. In the exhaust pipe assembly 66a, which employs a double-tube structure, both the exhaust pipe 66 and the heat transfer sheath 67 can also serve to contain any possible leakage of ambient gas. An exhaust pipe heater controller 682 can adjust the heating operation using the temperature of the heat transfer sheath 67 as an indicator. Furthermore, although the exhaust pipe heater 68 is represented as cylindrical in FIG. 12, various shapes of heating elements (heaters) can be employed. This is because the exhaust pipe 66 is heated evenly through the heat transfer sheath 67, so that uneven heating, such as a partial rise in temperature, is unlikely to occur.

### 4. ²¹¹At Production

Next, the production method for producing astatine 211 (²¹¹At) is described as a specific example of applying the present embodiment of radionuclide production. When employing the quantum beam irradiation system 1000 shown in FIG. 1, the method of producing radiation nuclides shown in FIG. 4, and the method of quantum beam irradiation shown in FIG. 8 to produce ²¹¹At, the target material 4 is ²⁰⁹Bi and an α-particle beam is used for the quantum beam 2. ²¹¹At is produced from ²⁰⁹Bi by a nuclear reaction expressed as Bi+a→²¹¹At+2n. What helps to increase the amount of ²¹¹At produced in the production of ²¹¹At in the present embodiment is the rotation of the target material container 3, etc., and the appropriate control of the temperature of the target material 4. By these, a high-current beam can be employed and the amount of ²¹¹At produced can be increased. In contrast, what helps to increase the yield in the production of ²¹¹At in the present embodiment is the process of extracting ²¹¹At from the target material 4 by appropriate control of the temperature of the target material container 3, etc., and the appropriate transport using ambient gas in the ambient gas exhaust system 65.

Since ²⁰⁹Bi has a melting point of 271.5° C., it can be melted by heating the target material container 3 to about 300° C., as described below. When the melted ²⁰⁹Bi is the target material 4, the target material container 3 can be rotated at a constant rotation speed for irradiating the target material 4 with an α-particle beam, which is a quantum beam 2, as shown in FIG. 6B. To make the incident energy of the beam optimal for production, for example, the acceleration energy of the α-particle beam should be about 28 MeV. This allows the target ²¹¹At to be produced efficiently. The above acceleration energy is preferable because the production of astatine 210 (²¹⁰At) by the ²⁰⁹Bi+α→²¹⁰At+3n reaction further produces long-lived polonium 210 by electron capture decay, thus keeping the amount of astatine 210 produced low. By irradiating the α-particle beam while rotating the target material container 3, it is expected that the intensity of the beam can be increased to about 500 μA (for a beam spot diameter of 9 mm) or even higher. As the beam intensity increases, the target material 4 is also heated by the beam, but this is not a particular obstacle to the continued irradiation of the α-particle beam to the target material 4, which is in a molten state inside the target material container 3. If the target material container 3 is properly temperature-controlled, overheating of the target material 4 can also be prevented. In a typical ²¹¹At production, the target material container 3 is rotated continuously during the irradiation of quantum beam 2. Thus, according to the present embodiment, it is possible to produce it in large quantities. When using the conventional method using a solid target for ²⁰⁹Bi (e.g., Non-Patent Document 2), the intensity of the α-particle beam had to be limited to a maximum of about 30 μA (for a beam spot diameter of 9 mm).

One of the preferred carrier gases for the production of ²¹¹At is helium gas. Under appropriate conditions, this gas, together with the carrier gas, can compose an ambient gas that can be discharged by ambient gas exhaust system 65 (FIG. 1). If an appropriate trap device 69 or other appropriate trap means is employed, the ²¹¹At produced can be efficiently trapped. Thus, according to the present embodiment, the produced ²¹¹At can be collected in high yield. The process of trapping ²¹¹At by trap device 69 can be performed in combination with the introduction of carrier gas by carrier gas supply system 61 and ambient gas exhaust system 65.

For example, by appropriately controlling the temperature of the target material 4, the amount of ²¹¹At that is detached from the target material 4 and transported by the ambient gas can be increased. In this configuration, by appropriately controlling the temperature of the ambient gas in the ambient gas exhaust system 65 that transports the ambient gas, the quantity of ²¹¹At that is trapped, i.e., the production of ²¹¹At, can also be increased. Here, in the case of ²¹¹At, the typical exhaust pipe 66 is a fluoropolymer tube, for example, a PFA (copolymer of tetrafluoroethylene and perfluoroalkoxyethylene) tube can be employed. In this case, to prevent ²¹¹At from being absorbed on the inner surface of the PFA tube, it may be useful to employ a heat transfer sheath 67 together with an exhaust pipe heater 68 to maintain the ambient gas at an appropriate temperature.

In the present embodiment, at least one or both of the transport step (FIG. 4, S06-S16) or the trapping step (FIG. 4, S08-S14) is preferably carried out in parallel with the irradiation step (FIG. 4, S10-S12; FIG. 8, S26), and it is not limited to the case of producing ²¹¹At. The fact that the radionuclides produced by the irradiation of the quantum beams 2 in the irradiation step are taken out in the transport and trapping steps that are carried out in parallel contributes directly to the production of radionuclides in large quantities with high efficiency. When the irradiation step is one in which the target material container 3, etc., is rotated around the axis of rotation 11 while the quantum beam 2 is irradiated with the irradiation axis 11 passing through the opening for irradiation 31 and the containing part 30, it is preferred that the irradiation step (FIG. 4, S10-S12; FIG. 8, S26) and the rotational drive step (FIG. 8, S24-S28) are performed in parallel. The capability to irradiate quantum beams with high intensity due to the rotation of the target material container 3, etc., also directly contributes to the production of radionuclides in large quantities with high efficiency. The same is true when the radionuclide to be produced is ²¹¹At. It is advantageous to continue the trap of ²¹¹At by trap device 69 while irradiating quantum beam 2 and rotating target material container 3. It is also advantageous to stop the introduction of carrier gas by the carrier gas supply system 61 and the ambient gas exhaust system 65 to collect the ²¹¹At trapped in the trap device 69.

### 5. Experimental Verification

We describe in detail the experimental verification that was conducted to confirm the feasibility and production capability of radionuclide production by the present embodiment. In this verification, the experiment was conducted adopting ²⁰⁹Bi for the target material 4 and assuming the production of ²¹¹At. In the present embodiment, experiments involving the irradiation of quantum beam 2 are referred to as on-line tests, while experiments not involving the irradiation of quantum beam 2 are defined and distinguished as off-line tests. The main purpose of the off-line test is to confirm whether the ²¹¹At produced as a result of the nuclear reaction can be trapped in high yield. The experiments were conducted six times from Experiment 1 to 6 in that order, of which Experiments 1 and 3 to 5 were off-line tests, and Experiments 2 and 6 were on-line tests.

The conditions common to Experiments 1 through 6 were as follows. First, a graphite (carbon) target material container with the shape of target material container 3D and 54 insulating supports (FIG. 11) were used. The target material container 3D was heated by an induction heating coil 302, and the power for the induction heating was controlled by measuring the temperature of the target material container 3D with a radiation thermometer (not shown). Amounts of 211 At content, production, and recovery were determined by measuring intensity of γ rays (radioactivity) generated from ²⁰⁷Bi, which is a decay product of ²¹¹At. Specifically, the radioactivity was quantified by γ-ray measurement of the trap using a CdTe detector during the experiment and a Ge semiconductor detector after the experiment. Note that the half-life of ²¹¹At is short (7.2 hours) enough, so ²¹¹At decreases during the test. In experiments, in order to compensate for this, all measured radioactivity values were corrected to a certain time before the test for comparison. For the experiments involving the rotation of the target material container 3D, a rotation speed of 800 rpm was used. However, we also conducted some experiments in which the target material container 3D was not rotated (Experiment 3 and part of Experiment 6).

### 5-1. Experiment 1

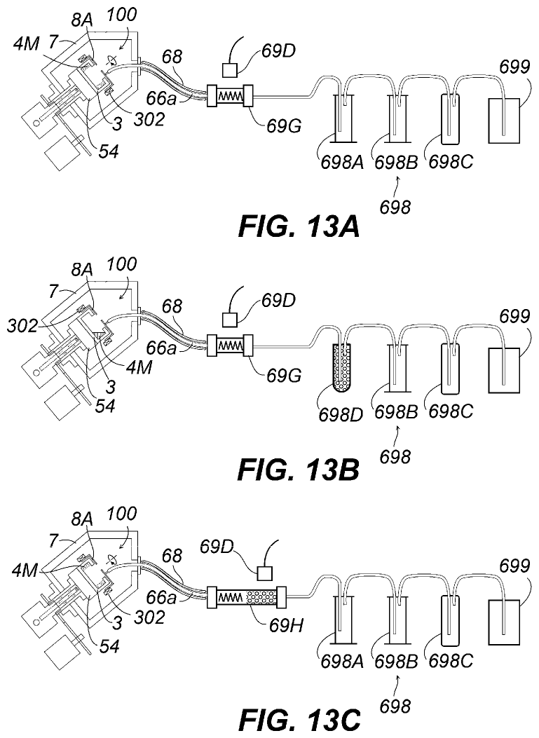

Experiment 1, an off-line test without irradiating quantum beam 2, was conducted for the purpose of confirming the possibility of trapping ²¹¹At using carrier gas while target material container 3 was rotating. FIGS. 13A-13C show the experimental configuration of the off-line tests conducted for experimental verification of the present embodiment, and FIG. 13A shows the first of the off-line tests (Experiment 1). The target holding device 100 is placed inside the airtight target chamber 7. In the target material container 3 of the target holding device 100, a ²⁰⁹Bi sample containing ²¹¹At produced by transmutation after irradiation with α-particles is placed for a mock target material 4M, which imitates the target material 4. The amount of ²¹¹At in the mock target material 4M was a fraction corresponding to 100 kBq of radioactivity. The carrier gas was gaseous helium flowing at a flow rate of 0.1 L/min. The target material container 3, which was housing the mock target material 4M, was heated by an induction heating coil (not shown in FIG. 13A) to heat and rotate the target material container. The container cover 8A shown in FIG. 10A was employed to increase the yield. The target material container 3 was heated to 660° C. The trap device that collects the ²¹¹At is a gold foil trap 69G and the detector 69D is a CdTe detector or Ge semiconductor detector. The exhaust pipe assembly 66A leading to the gold foil trap 69G was kept at a temperature of about 140° C. in the heat transfer sheath 67 (not shown in FIG. 13A) by placing an exhaust pipe heater 68. The exhaust pipe 66 inside the exhaust pipe assembly 66a is a fluoropolymer (PFA) tube and the heat transfer sheath 67 is a copper tube. A trapping system 698 including a buffer 698A, an air wash bin 698B, and an activated carbon column 698C with vacated containers was connected before the exhaust pump 699 to control the leakage of radioactive materials including ²¹¹At. The inside of the target chamber 7 was maintained at a slightly negative pressure compared to atmospheric pressure by adjusting the amount of carrier gas supplied from the carrier gas supply system 61 and the flow rate of the exhaust pump 699. In this way, the conditions were set so that the amount of carrier gas supplied corresponded to the amount of ambient gas vented from the ambient gas exhaust system 65 at the opening 31.

As a result, ²¹¹At was not detected in the gold foil trap 69G and was adsorbed on the induction heating coil 302. This at least confirms that raising the temperature of target material container 3 to 660° C. is useful for expelling ²¹¹At from the mock target material.

### 5-2. Experiment 2 (On-Line Test)

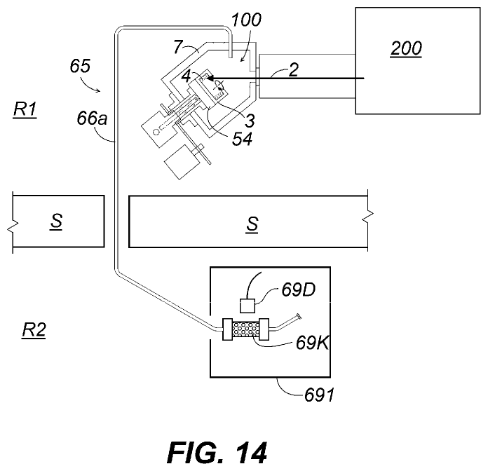

As Experiment 2, we confirmed whether ²¹¹At is transported by carrier gas (helium gas), in a situation in which ²¹¹At is continuously produced was performed by actually irradiating quantum beam 2 to ²⁰⁹Bi, the target material 4. FIG. 14 is an illustration of the experimental configuration of Experiment 2, an on-line test conducted for experimental verification in the present embodiment. The irradiation room R1 is used for the irradiation with the quantum beam 2. To verify the possibility of collecting the ²¹¹At generated simultaneously with the irradiation, the ambient gas exhaust system 65 was extended to an adjacent room (laboratory room R2) shielded from the irradiation room by a shield S to check whether the ²¹¹At could be collected in the gold foil trap 69G. Here, in Experiment 2, the exhaust pipe assembly 66a was employed for the ambient gas exhaust system 65, but the exhaust pipe heater 68 was not used. The gold foil trap 69G was installed in the hood 691. Although not shown in FIG. 14, the trap system 698 and exhaust pump 699 are installed in the hood 691 as in FIGS. 13A-13C. During the irradiation of the quantum beam 2, the gaseous helium flow rate was 0.1 L/min, the container cover was not used, and the target material container 3 was kept at its temperature of 400° C. and the rotation was activated.

As a result, it was confirmed that ²¹¹At was collected by the gold foil trap while irradiating with the quantum beam 2. The amount of ²¹¹At produced was 27 MBq, of which 3.62 kBq was collected in the gold foil trap. This was confirmed to result in a yield of 0.013%. In the target material container 3, it was also confirmed that the target material 4 was held by centrifugal force as it was melted and spread over the inner surface 33, and was repeatedly positioned according to the rotation of the target material container 3 at the position where the quantum beam 2 was kept parallel to the horizontal plane 9 and irradiated as shown in FIG. 6B.

### 5-3. Experiment 3

In Experiment 3, an off-line test similar to Experiment 1 without quantum beam 2 irradiation was conducted to confirm the effect of the yield improvement. This yield improvement could be attributed to the mechanical configurations around the target material container 3. The experimental configuration is shown in FIG. 13B, and its schematic diagram is similar to FIG. 13A. However, as shown in FIG. 13B, charcoal trap 698D was employed instead of buffer 698A. In Experiment 3, container cover 8A shown in FIG. 10A was employed, and the rotation of target material container 3 was stopped to make the circumference of container cover 8A adhere to target material container 3, and the gaseous helium flow rate was increased. This aimed to minimize the amount of ²¹¹At spreading into the target chamber 7 through the gap between the target material container cover 8A and the mock target material 4M, and also to suppress the discharge of ²¹¹At from the opening for irradiation 82. Because the target material container 3 was not rotated, the mock target material 4M accumulated in the lower part of the target material container 3. The temperature of the target material container 3 was raised between 40° and 750° C. in 50° C. increments to investigate the optimum temperature conditions at which At could be recovered. The gaseous helium flow rate was set at 0.5 L/min. The amount of ²¹¹At in the 4M mock target material at the beginning of the experiment was a quantity corresponding to 2937 kBq of radioactivity.

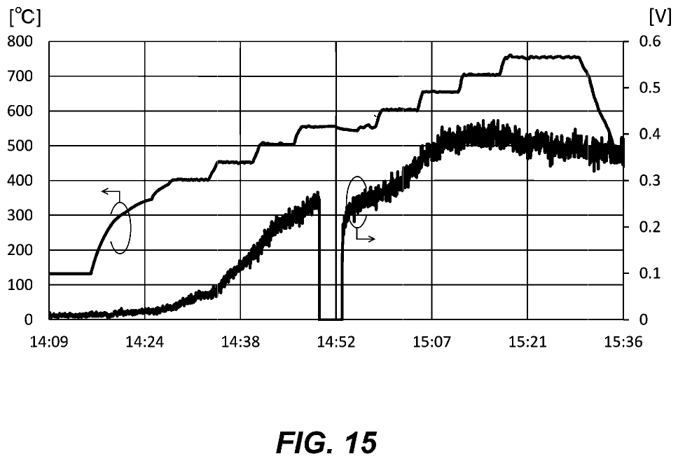

FIG. 15 is a graph showing the time variation of the temperature of the target material container measured in Experiment 3 and the respective values of the counts of radiation output in voltage by the detection operation directed to the gold foil trap. The counts of radiation (right axis) indicate the intensity of ²¹¹At adsorbed on the gold foil trap 69G. More specifically, in this experimental sequence, ²⁰⁹Bi irradiated with an α-particle beam was mounted as a mock target material 4M in the containing part 30 of the target material container 3, which was at rest. The temperature of the target material container 3 (left axis) was measured by a radiation thermometer. Therefore, the measured value at the lower limit that the radiation thermometer can measure (140° C.) appears in the graph, but in reality, the heating was started from room temperature. The gas helium flow rate was then controlled to 0.5 L/min and maintained throughout the experiment. From this state, the target material container 3 was raised to 400° C. to melt the ²⁰⁹Bi. From this point, the temperature of the target material container 3 was increased in trapping steps to investigate the relationship between the temperature of the target material container 3 and the ability of the target material container 3 to trap ²¹¹At. Specifically, the temperature of the target material container 3 was increased in steps of 50° C. from 400° C. to 750° C. Each step lasted 5 minutes. Each step was set for five minutes each. As a result, it was confirmed that ²¹¹At began to be trapped at temperatures above 450° C., and the amount of ²¹¹At trapped increased in step with the heating of the target material container 3. On the other hand, previous Bi heating tests have also shown that evaporated Bi is deposited on the container cover 8A when the temperature of the target material container 3 is increased. If At in the ambient gas adheres to the Bi deposited on the vessel cover 8A surface or on the exhaust pipe, it may adversely affect the At trap, so it is desirable to collect At at the lowest possible temperature. Based on the above, it was found that 450-650° C. is a suitable target material container 3 temperature for At recovery.

It should be noted that there is a time period during which the value of the ratemeter (Ratemeter) corresponding to the number of radiation counts is zero. This is a period when the power supply was not supplied for approximately 3 minutes due to a power failure of the exhaust pipe heater or the measurement device. During this period, the induction heating coil 302 was operating and He flow was stopped. This not only increased the retention time, but may have reduced the yield of At. Moreover, it can be confirmed from FIG. 15 that a large amount of At began to be collected when target material container 3 was held at 450° C. or higher, and the amount of At recovered did not increase even when the temperature exceeded 650° C. This is presumably due to the fact that most of the At has evaporated from the ²⁰⁹Bi sample by holding the target material container 3 at 650° C. If At remains, At can be recovered even if the target material container 3 is held at temperatures above 650° C.

The exhaust pipe assembly 66a up to the gold foil trap 69G was kept at a temperature of about 140° C. in the heat transfer sheath 67 by deploying the exhaust pipe heaters 68. The temperature of the target material container 3 was set at 400° C. and increased to 750° C. in 50° C. steps and held at each temperature for 5 minutes. At the end of all temperature control steps, ²¹¹At was collected in the gold foil trap and activated carbon trap, and approximately 1736 kBq equivalent was collected out of the total amount of ²¹¹At (2937 kBq equivalent), which resulted in a yield of 61%. We have thus confirmed that At can be efficiently collected and that increasing the gas helium flow rate can be helpful when controlling the flow of the ambient gas exhaust system using the container cover 8A in the mechanical configuration in the vicinity of the target material container 3.

### 5-4. Experiment 4

Experiment 4 was conducted to test whether it is possible to trap ²¹¹At by increasing the temperature of target material container 3D while rotating it, although this does not involve irradiation of quantum beam 2. The experimental configuration is shown in FIG. 13C, and its schematic diagram is almost the same as in FIG. 13A. However, as shown in FIG. 13C, a 69H gold foil/charcoal combination trap was employed. In Experiment 4, the container cover 8A shown in FIG. 10A was employed and the target material container 3D was rotated. The temperature of the target material container 3D was set at 450-650° C. (50° C. steps), and the gaseous helium flow rate was 0.5 L/min. The amount of ²¹¹At in the target material 4 was corresponding to 1112 kBq of radioactivity.

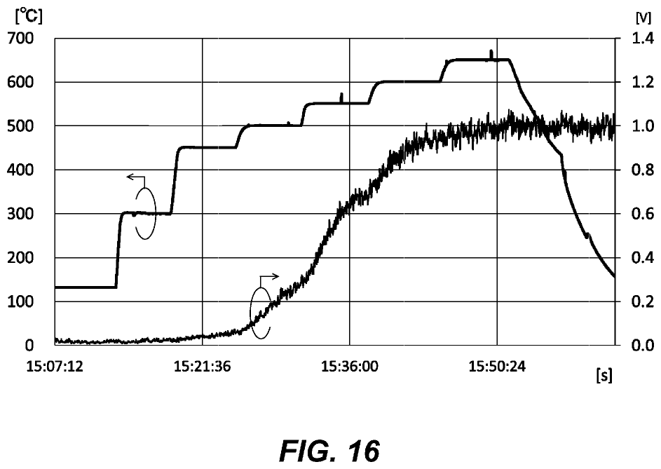

As a result, the radioactivity of ²¹¹At collected in the gold foil trap and activated carbon column was 558 kBq out of the total amount of ²¹¹At (1030 kBq), and the yield was 50.2%. Furthermore, the relationship between the temperature of the target material container 3D and the trap of ²¹¹At was also revealed in the process. FIG. 16 is a graph showing the temperature of the target material container 3D measured in Experiment 4, which was conducted for experimental verification in the present embodiment, and the temporal dependence of the radiation counts output as a voltage by the detection operation to the activated carbon trap, respectively. All temperatures of the target material container 3D are the surface temperature of the target material container 3D measured by a radiation thermometer, while the target material container 3D was heated by the induction heating coil 302. Specifically, in this experimental sequence, ²⁰⁹Bi irradiated with an α-particle beam was first mounted as the mock target material 4M in the containing part 30 of the stationary target material container 3D, and the target material container 3D was set at about 130° C. The gas helium flow rate was then controlled to 0.5 L/min and it was maintained throughout the experiment. From these conditions, the target material container 3D was raised to 300° C. to melt the ²⁰⁹Bi. The target material container 3D was then rotated to 800 rpm and it was maintained throughout the experiment. The situation simulated in this step is that ²¹¹At is produced in the target material 4 through transmutation induced by the irradiated quantum beam 2, and the target material container 3D is spinning. From this point, the relationship between the temperature of the target material container 3D and the ability to trap ²¹¹At was investigated by increasing the temperature in steps. Specifically, the temperature of the target material container 3D was increased from 450° C. to 650° C. in 50° C. steps. These steps lasted for 5 minutes each. As a result, it was confirmed that the trapped ²¹¹At increased in step with the heating of the target material container 3D. In particular, it was confirmed that ²¹¹At was efficiently transported by the carrier gas when the target material container 3D was heated to 500° C. or 550° C. In comparison with Experiment 3, the yield of radioactivity in the 69H gold foil/charcoal combination trap was reduced by about 10%. This may be due to the inability to tightly fit the container cover to the rotating target material container and the effect of the rotation on the ambient gas, which impeded the flow to the exhaust tube. A closer look at the distribution of yields shows that it was 49.0% in the charcoal trap and 1.2% in the gold foil trap.

### 5-5. Experiment 5

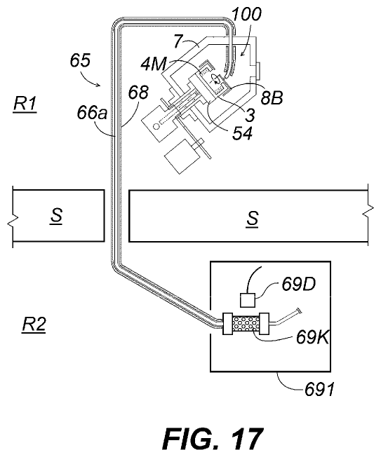

Experiment 5 was conducted to estimate the yield of ²¹¹At production with the same ambient gas exhaust system 65 path arrangement and actual distance as in the on-line test (Experiment 2), although the quantum beam 2 irradiation was not performed. FIG. 17 illustrates the experimental configuration of Experiments 5 and 6 (described below), which are off-line tests conducted for experimental verification in the present embodiment. Based on the findings of Experiment 4, the target material container 3D containing the same mock target material 4M as in Experiment 4 was rotated to adjust its temperature, a container cover 8B was employed, and a charcoal trap 69K was employed instead of a gold foil trap. In Experiment 5, unlike Experiment 2 (FIG. 14), the ambient gas exhaust system 65 was configured as an exhaust pipe assembly 66a with the heat transfer sheath 67 and exhaust pipe heater 68, the quanta generator 200 was not connected, and the vessel cover 8B was adopted; other than these, the configuration was the same as in Experiment 2. The path of the ambient gas exhaust system 65 extended approximately 12 m from the irradiation room to the laboratory room, which was separated by the shield. In the path of that ambient gas exhaust system 65, the temperature was controlled by the exhaust pipe heater 68 as far as possible in the length direction, including inside the target chamber 7, so that the temperature of the exhaust pipe 66 and heat transfer sheath 67 inside the exhaust pipe assembly 66a actually reached 110° C. The temperature of the target material container 3D was set at 450-650° C. (in 50° C. steps), and the gas helium flow rate was set at 0.5 L/min.

As a result, the yield of ²¹¹At collected in activated carbon column 698C was 38%, confirming that 211At can be collected in a practical yield by the remote arrangement across the irradiation room and the laboratory room. In addition, it was confirmed in Experiment 5 that the temperature of the heat transfer sheath 67 was sufficient at 110° C. at the highest, without the need for 140° C.

### 5-6. Experiment 6 (On-Line Test)

### 5-6-1. Experiment and Results

As an on-line test to confirm both irradiation and trap, we conducted Experiment 6, in which the target holding device 100 configuration shown in FIG. 17 was further connected to a quanta generator 200, as an actual on-line test. The criterion for the amount of At produced in that experiment was determined as follows. A Bi plate (0.5 mm thick) was previously irradiated with a 120 nA α-particle beam for 5 minutes and the radioactivity was measured with a Ge semiconductor detector. When solid Bi is irradiated with the beam, almost all of the generated At remains in the solid Bi without migrating into the ambient gas. Therefore, by measuring the radioactivity of the Bi plate, the amount of At produced in relation to the amount of beam irradiated can be quantified. This was used as a criterion for the amount of At produced in the beam irradiation test. In other words, if Bi is selected for the target material 4 and the ratio of the radioactivity of At trapped in the trap to the beam current irradiated to it is the same as that of this Bi plate, the yield is 100%; if half of the radioactivity is measured, the yield is 50%. This yield takes into account the amount of At produced in the rotational operation of the target holding device 100 and the amount of At collected by the radionuclide trap system 6.

Some error factors that affect quantitate aspect will be briefly discussed. First, the intensity of the α-particle beam fluctuates, which can cause errors in the current values when measured with a Faraday cup. Second, there may be the influence of previous experiments. This is due to several experimental constraints. That is, the chamber cannot be opened immediately after the irradiation test because the generated At would be released into the atmosphere. Reproducibility may not be achieved because evaporated Bi may be deposited on the chamber cover and ambient gas exhaust system, and At may be adsorbed. In addition, At produced in the previous test may remain in the Bi target, which may affect the results of subsequent tests.

The following measures were taken to address these error factors. For the first point, we decided to irradiate the α beam before and after irradiation to the Faraday cup, measure the current values, and adopt the average value of the current values of the irradiated beam as its predicted value. With this approach, we believe that we can still predict the current value of the actual beam with an error of about ±10%, although this average value does not necessarily match the current value fluctuating in the actual beam. Regarding the second point, after each test, we performed an operation in which the target material container 3 was held at a high temperature for a certain period of time for the purpose of discharging all the At remaining in the Bi target. This operation was adopted because the radioactivity detected by the CdTe detector after the first test was kept at 650° C., and the radioactivity became constant after 10 minutes. This operation was performed at the confirmed 650° C. for 10 minutes, and it was performed every time the test conditions were changed. Even after conducting the test with these measures, the tendency for the yield to decrease as the test continued could not be eliminated.

In Experiment 6, the irradiation trap test was repeated, each involving one cycle of irradiation and trap. These are distinguished from No. 1 through No. 14 in this section. Table 1 lists the conditions and results of the irradiation trap tests.

| | | Beam | | Activity at | Calculated | | | | | | Gas flow |
|---|---|---|---|---|---|---|---|---|---|---|---|
| | | Current | Irradiation | EOB | Activity at | Yields of | | Rotation | Separator | | rate |
| Trap No | | (μA) | time (min) | (kBq) | EOB (kBq) | trap (%) | | (800 rpm) | temperature | | (L/min) |
| No. 1 | | 0.2 | 5 | 479.0 | 440.0 | 108.9 | | No | 450-650° | C. | 0.5 |
| No. 3 | | 0.2 | 5 | 34.6 | 382.6 | 9.1 | | Yes | 450° | C. | 0.5 |
| No. 4 | | 0.2 | 5 | 144.6 | 456.6 | 31.7 | | Yes | 550° | C. | 0.5 |
| No. 5 | | 0.2 | 5 | 212.1 | 452.5 | 46.9 | | Yes | 650° | C. | 0.5 |
| No. 9 | | 0.2 | 5 | 242.0 | 455.6 | 53.1 | | No | 600° | C. | 0.5 |
| No. 10 | | 0.2 | 5 | 319.6 | 444.7 | 71.9 | | No | 600° | C. | 1.0 |
| No. 12 | | 10 | 5 | 21352.9 | 20028.3 | 106.6 | | No | 650° | C. | 1.0 |
| No. 13 | | 10 | 5 | 18254.7 | 19665.1 | 92.8 | | Yes | 650° | C. | 1.0 |
| Cold | No. 14 | 10 | 5 | 4684.1 | 19353.7 | 24.2 | 63 | Yes | 650° | C. | 1.0 |

| | | |
|---|---|---|
| trap | vial | 24.8 |
| | tube | 14.0 |

The columns of Table 1 are as follows. The first column is the number for the irradiation trap test. The second and third columns are the conditions related to the beam, i.e., the current value of the beam intensity (μA) and the irradiation time (minutes). The fourth to sixth columns show the measured radioactivity (kBq) at the end of bombardment (EOB) and the calculated radioactivity (kBq) and yield (%) at the end of irradiation. The seventh column indicates whether the target material container 3 was rotated or not during the trap process (S08-S14, FIG. 4). The eighth column is the temperature range (or final temperature reached) during the separation, or trap process (S08-S14, FIG. 4). The ninth column is the helium gas flow rate (L/min), which is the carrier gas. In addition, each row of Table 1 is as follows. The first row is the name of the item in the table; the second to ninth rows are the conditions and results of irradiation collection tests Nos. 1 to 13; the eleventh to thirteenth rows are the conditions and results of No. 14; the eleventh through thirteenth rows are the conditions and results of No. 14 and the measured residual radioactivity in cold trap 696 (FIG. 3C) at that time, in vial 697 and in the PFA tube of cold trap 696, respectively. The description of the test results for Nos. 2, 6-8, and 11 is omitted.

Next, each irradiation trap test is described. In the No. 1 test, the unheated target was irradiated with a 0.2 uA beam while rotating. After the rotation was stopped, the temperature of the target material container was increased from 450 to 650° C. in 50° C. steps. Each step lasted for 5 minutes, and only the last step, 650° C., was held for 10 minutes. The total heating time was about 36 minutes, including the temperature increase time. The gas helium flow rate was 0.5 L/min. The amount of At obtained in the charcoal trap 69H was 479.0 kBq of radioactivity, and a yield of 108.9% was obtained. This value is due to the inclusion of errors as mentioned above, and the exact yield does not exceed 100%. However, it can be said that almost the entire amount of At produced was transported from the target chamber.

Nos. 3 to 5 are the tests of changing the temperature of recovery: No. 3 was irradiated at 450° C. for 5 minutes and held at the same temperature for 5 minutes; No. 4 and No. 5 were tested at 550° C. and 650° C., respectively. The irradiation and holding temperatures were the same, and the holding time was 5 minutes in each case. The target material container 3 was rotated for collection. Other conditions were the same as in No. 1. As a result, the amounts of At obtained in the trap were 34.6 kBq, 144.6 kBq, and 212.1 kBq, respectively, and the yields were 9.1%, 31.7%, and 46.9%, respectively. From the test of Nos. 3 to No. 5, it was confirmed that the higher the temperature at which At is recovered, the better the yield is, and that At is collected at a high yield even when the target material container is rotated.

Nos. 9 and 10 are tests of varying the gas helium flow rate. No. 9 was performed at 0.5 L/min, the same as before, and No. 10 at 1.0 L/min. The irradiation of the beam was performed at a temperature in the target material container of 140° C. Collection was carried out at 600° C. for 25 minutes. The collection was conducted with the rotation stopped. As a result, the amount of At obtained in the trap was 242.0 kBq and 319.6 kBq, respectively, and the yields were 53.1% and 71.9%, respectively. From the tests of No. 9 and 10, it was confirmed that increasing the gaseous helium flow rate produced better yields and had a significant effect on improving the yields.

Nos. 12 and 13 are tests under the condition of 10 μA beam irradiation when the target material container 3 was rotated and not rotated, respectively, during the trap. The amount of At obtained in the resulting traps was 21352.9 kBq and 18254.7 kBq of radioactivity, and the yields were 106.6% and 92.8%, respectively. From the tests of Nos. 12 and 13, it was confirmed that very high yields were obtained even at high currents.

No. 14 was a test using a cold trap. The location of the cold trap was as described in FIG. 3A. This test was designed to be used for real applications of medicines. The conditions employed were the same as in No. 12, the condition under which the highest values were obtained. As a result, the amount of At obtained in the vial 697 (FIG. 3C) was 4809.2 kBq, the amount of At remaining in the PFA tube was 2717.0 kBq, and the amount of At not collected in the cold trap but measured in the charcoal trap (FIG. 3A, part of trap system 698) at the later stage was 4684.1 kBq. The yields were 24.8%, 14.0%, and 24.2%, respectively. We confirmed from the test of No. 14 that a sufficiently high yield can be achieved even when At is produced on a realistic scale. Although the yield tended to decrease as the experiment continued, a very high yield was obtained when the beam was irradiated at 10 μA.

5-6-2. Additional Findings with High Current Beams

In tests of Nos. 12 to 14, a relatively high current beam of 10 μA was irradiated. Specifically, after the test of No. 14, Bi particles were found in the vial 697 (FIG. 3C) in which At was collected. This phenomenon was not observed in the off-line tests. The cause of this phenomenon is thought to be evaporation of Bi due to the large current beam, followed by the formation of microscopic particles (fumes) as the evaporated Bi cooled down. Relatively large Bi particles were also observed in the vial 697, which are thought to be particles that jumped due to the local heating by the beam. These Bi particles were carried by ambient gas and reached the cold trap. It is thought that these Bi particles carried a large amount of At and contributed to the improved yield. Contrary to Non-Patent Document 3 and Patent Document 2, the Bi target material itself is vaporized or dispersed and becomes an aerosol due to the strong α-particle beam irradiation in the present embodiment, and this phenomenon itself is considered to have a favorable effect on At transport. Thus, it can be said that the irradiation process in the quantum beam irradiation system in the present embodiment, which can stably irradiate with a strong α-particle beam in a heated state with melted Bi, is advantageous for At transport.

### 5-7 Summary of Experiments and Applicability to ²¹¹At Production

From the above Experiments 1 through 5, the highest yield for ²¹¹At trap was 61% (Experiment 3) with the target material container 3D stationary, and the highest yield was 50.2% (Experiment 4) with the target material container 3D rotated. The ²¹¹At extracted from the ²⁰⁹Bi, which is melted and rotated under the temperature control of the target material container 3D as in Experiment 4 with a high yield of about 50%, can be transported to a remote location of about 12 m (Experiment 5) as long as the ambient gas containing the ²¹¹At is properly temperature-controlled. Furthermore, from Experiment 6, it was confirmed that the irradiation and trapping in the irradiation process by the present embodiment of the quantum beam irradiation system have sufficient practicality to be applied in a practical scale. From these experimental confirmations, it can be said to be preferable from the viewpoint of practicality that the target material container 3D is heated up to 500° C. or 550° C., and that the ambient gas containing gaseous helium and ²¹¹At, which is the carrier gas, is transported by a heated exhaust pipe, even in the case of implementing the production method of producing ²¹¹At by irradiating ²⁰⁹Bi targets with α-particle beams.

### 5-8. Utilization of Aerosols for 211At Production

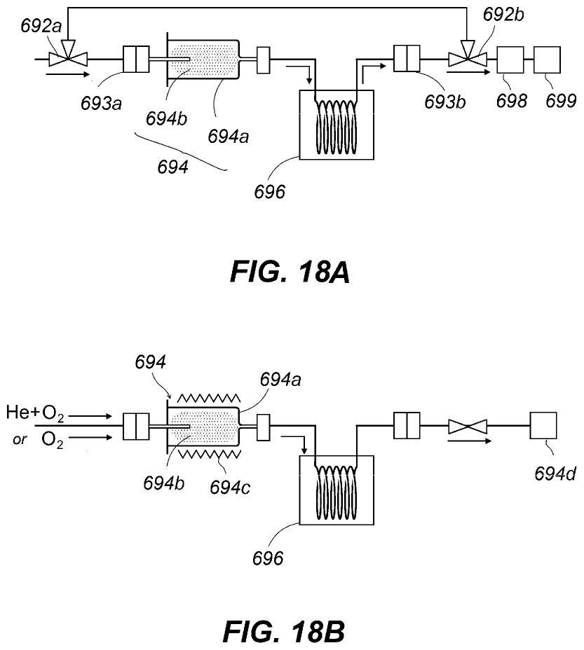

The knowledge of aerosols in high-current beams (Section 5-6-2 above) can be advantageous in terms of increasing yields. At the same time, Bi particles must be removed from the ²¹¹At that can be used as medicines. The following two methods for Bi particle removal are useful. FIGS. 18A and 18B show the structure of a trap device (FIG. 18A) and an illustration of its operation (FIG. 18B), which are suitable in the case that Bi particulates are produced in the present embodiment.

In the first method of Bi particle removal, a particulate filter 694 is connected in series upstream of the cold trap 696 between fittings 693a and 693b shown in FIG. 3a, as shown in FIG. 18a. The particulate filter 694 is equipped with a quartz tube 694a filled with quartz wool 694b. This quartz wool 694b is used to trap these particles. This operation constitutes a part of the trapping step. The system is then disconnected by a valve, as shown in FIG. 3B, and the At desorption line, shown in FIG. 18B, is used to desorb the At from the Bi particles (sublimation step). In other words, the 694 particle filter is heated to a high temperature (e.g., 850° C.) by a heater 694c such as an electric furnace while a mixture of gas helium mixed with oxygen or oxygen gas flows through it using an exhaust pump 694d. This causes At to sublimate from the Bi particles contained in the quartz wool 694b, and the At is trapped in the cold trap 696 downstream of the quartz tube 694a. The reason for adding oxygen is to facilitate the release of At from solid Bi and to adjust the valence (i.e., chemical species) of At to make it easier to trap it in the cold trap 696. The At can then be recovered from the cold trap 696 using the solvent elution system 69a shown in FIG. 3C. These operations prevent Bi from mixing with the At solution, and also enable the recovery of At adsorbed on Bi particles without waste. In this first method, the above sublimation step is carried out after the trapping step.

The second method for Bi particle removal is to perform the separate operations shown in FIGS. 18A and 18B in the first method in a single system. This allows the sublimation step to be performed in parallel with the trapping step or in parallel with the irradiation step, in addition to after the trapping step. Specifically, in this method, the particulate filter 694 is connected in series upstream of the cold trap 696, as in FIG. 18A, an inflow system (not shown) is added upstream of the particulate filter 694 to additionally mix oxygen, and an additional heater is placed around the quartz tube 694a, similar to the arrangement of heater 694c in FIG. 18B. In this structure, oxygen is mixed into the ambient gas upstream of the particulate filter 694 while the ambient gas from the target chamber 7 is being passed through the cold trap 696 using the exhaust pump 699, and at the same time the temperature of the particulate filter 694 is raised to a high temperature (for example, 850° C.) by the heater 694c This is the sublimation step. If this operation is performed in parallel with the trapping step, At is easily collected in the cold trap 696. Then, as in the first technique, At can be recovered from the cold trap 696 by using the solvent elution system 69a shown in FIG. 3C. In this second technique, the above sublimation step can be carried out in parallel with the trapping step, as the processes carried out separately as shown in FIG. 18A and FIG. 18B are carried out in a single system. Furthermore, since the trapping step can be carried out in parallel with the irradiation step, the above sublimation step can be carried out in parallel with the irradiation step.

### 6. Conclusion

The embodiments of the present disclosure have been described in detail in the above. Each of the above embodiments, variations, and experimental verifications are described to explain the disclosure, and the scope of the present disclosure should be determined based on the claims. Variations that exist within the scope of the present disclosure, including other combinations of the embodiments, are also included in the scope of the claims. That is, those skilled in the art may make various changes, combinations, subcombinations, and substitutions with respect to the components in the present embodiments described above, within the technical scope of the present disclosure or its equivalents.

### INDUSTRIAL APPLICABILITY

The method of producing a radionuclide and the target holding device, system, and target for quantum beam irradiation of the present disclosure can be used for either the production of any radionuclide and any device for irradiating the target material with a quantum beam and any process that utilizes said irradiation.

The various embodiments described above can be combined to provide further embodiments. All of the patents, patent application publications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### Reference Signs

1 target
1000, 1000A, 1000B, 1000C quantum beam irradiation system
100 target holding device
11 axis of rotation
12 generatrix
200 quanta generator
2 quantum beam
22 vacuum window
3, 3A, 3B, 3C, 3D target material container
30 containing part
31 opening
32 surrounding wall
33, 33A inner surface
34 base
36 inner flange
38 side cover section
302 induction heating coil (container heater)
304 matching device
306 high frequency power supply
312 radiation thermometer
322 controller (container heater controller)
4 target material
4M mock target material
5 rotational drive mechanism
54 insulating support
542 surrounding wall
544 heat transfer regulation holes
546 base
55 rotation feedthrough unit
56 rotary coupling
57 spindle
58 rotation transmitting mechanism
59 motor
6 radionuclide trap system
61 carrier gas supply system
65 ambient gas exhaust system
66 exhaust pipe
66a exhaust pipe assembly
67 thermal conductive sheath
68 exhaust pipe heater
682 exhaust pipe heater controller
69 collection device
69A solvent elution system
69D detector
69G gold foil trap
69H gold foil/charcoal combination trap
69K charcoal trap
691 hood
692a, b three-way valve
693a, b, c, d fittings
694 particulate filter
694a quartz tube
694b quartz wool
694c heater
694d exhaust pump
695 liquid transfer pump
696 cold trap
697 vials
698 trap system
698A buffer
698D charcoal trap
698B gas washing bottle
698C activated carbon column
699 exhaust pump
7 target chamber
8A, 8B container cover
82 opening for irradiation
84 exhaust tube port
86 side cover section
9 horizontal floor
S shield
R1 irradiation room
R2 laboratory room

1. A method for producing a radionuclide by quantum beam irradiation, comprising:
placing, in an installation step, a target material containing a target nuclide for quantum beam irradiation inside a target chamber in which the target material can be irradiated with a quantum beam from a quanta generator;
irradiating, in an irradiation step, at least a portion of the target material with the quantum beam;
supplying, in a transport step, a carrier gas to the inside of the target chamber and sending an ambient gas surrounding the target material to the outside of the target chamber through an exhaust pipe; and
using, in a trapping step, a trap device connected to the exhaust pipe to trap from the ambient gas at least one of a first radionuclide produced from the target nuclide by the quantum beam irradiation or a second radionuclide, which is at least one of a descendant nuclide obtained from the first radionuclide through radioactive decay.

2. The method for producing a radionuclide according to claim 1, wherein at least one or both of the transport step and the trapping step are performed simultaneously with the irradiation step.

3. The method for producing a radionuclide according to claim 1, wherein:
the target material is placed in a containing part of a target material container,
the target material container has the containing part and an opening through which the containing part is connected to an external environment,
the target material container is rotatable around an axis of rotation passing through the containing part and the opening, and
the target material container is placed inside the target chamber,
the method further comprising rotating, in a rotational drive step, the target material container about the axis of rotation.

4. The method for producing a radionuclide according to claim 3,
wherein the irradiation step and the rotational drive step are performed simultaneously, and
wherein the irradiation step is performed with the target material container being rotated about the axis of rotation while irradiating with the quantum beam having an irradiation axis passing through the opening and the containing part.

5. The method for producing a radionuclide according to claim 3,
wherein the quantum beam is an alpha particle beam,
wherein the target nuclide is bismuth 209 (²⁰⁹Bi),
wherein the first radionuclide is astatine 211 (²¹¹At), and
wherein, in the trapping step, ²¹¹At is ready to be trapped.

6. The method for producing radionuclides according to claim 5, further comprising heating the target material container during either the transport step or the irradiation step.

7. The method for producing a radionuclide according to claim 5, wherein the transport step includes delivering the ambient gas through the exhaust pipe while the exhaust pipe is heated.

8. The method for producing a radionuclide according to claim 5, wherein, in the exhaust pipe, a particulate filter is connected in series upstream of the trap device,
the method further comprising a sublimation step in which the particulate filter is heated to enable trapping of ²¹¹At downstream of the particulate filter in the sublimation step.

9. A method for quantum beam irradiation, comprising:
placing, in an installation step, a target material for quantum beam irradiation is in a containing part of a target material container, the target material container having the containing part and an opening through which the containing part is connected to an external environment and being rotatable around an axis of rotation passing through the containing part and the opening;
rotating, in a rotational drive step, the target material container about the axis of rotation; and
irradiating, in an irradiation step, at least a part of the target material with a quantum beam, wherein the quantum beam has an irradiation axis passing through the opening and the containing part while the target material container is rotated.

10. The method according to claim 9,
wherein the target material container has a base and a surrounding wall extending from the base, the base and the surrounding wall demarcating at least a portion of the containing part from outside,
wherein the rotational drive step includes pressing at least a portion of the target material by centrifugal force against the surrounding wall that surrounds the containing part; and
wherein the irradiation step includes irradiating at least a portion of the target material being pressed against the surrounding wall with the quantum beam while the irradiation axis is directed at the surrounding wall.

11. The method according to claim 9,
wherein the target material is in one of the following states: solid, liquid, or a mixture of solid and liquid.

12. The method according to claim 9,
wherein the target material in the installation step contains a solid, and
wherein at least a portion of the solid in the target material is molten at least temporarily during a period of time in which the irradiation step is performed.

13. A target holding device for quantum beam irradiation, comprising:
a target material container having a containing part for a target material to be irradiated with a quantum beam and an opening through which the containing part is connected to an external environment, wherein the target material container is rotatable about an axis of rotation passing through the containing part and the opening, and
a rotational drive mechanism configured to generate a drive force for rotation of the target material container.

14. The target holding device according to claim 13,
wherein the target material container has a base and a surrounding wall extending from the base,
wherein the base and the surrounding wall demarcate at least a portion of the containing part from outside, and
wherein the axis of rotation further passes through the base.

15. The target holding device according to claim 14, wherein the target material container has an inner surface on the surrounding wall, the inner surface being a surface of revolution having the axis of rotation as its central axis.

16. The target holding device according to claim 15, wherein the surface of revolution is part of a cylindrical or conical surface, the cylindrical or conical surface having an axis that is the central axis or the axis of rotation, and
wherein a generatrix that generates the cylindrical or conical surface and the axis of rotation are parallel to each other or form an angle of greater than 0° and less than 20°.

17. The target holding device according to claim 14, wherein the target material container further comprises an inner flange extending from the surrounding wall toward the opening.

18. The target holding device according to claim 14, wherein the rotational drive mechanism is capable of adjusting a rotational speed of the target material container so that at least a portion of the target material is repeatedly positioned in an irradiation area of the quantum beam while being pressed by centrifugal force toward an inner surface of the surrounding wall.

19. The target holding device according to claim 13, wherein the axis of rotation is arranged with respect to the quantum beam so that the axis of rotation is non-parallel to an irradiation axis of the quantum beam.

20. The target holding device according to claim 14,
wherein the axis of rotation is oriented such that it is tilted from a horizontal plane, and
wherein the quantum beam has an irradiation axis contained in a horizontal plane and is directed to irradiate through the opening to the target material which is being pressed by centrifugal force against an inner surface of the surrounding wall.

21. The target holding device according to claim 14, wherein the target material container comprises a conductive material.

22. The target holding device according to claim 14, wherein the target material container consists of a carbon material.

23. The target holding device according to claim 13, wherein the rotational drive mechanism is in thermal contact with the target material container and has a heat transfer member extending along the axis of rotation.

24. The target holding device according to claim 13, wherein the rotational drive mechanism has a heat transfer adjusting structure that impedes heat transfer between the rotational drive mechanism and the target material container.

25. The target holding device according to claim 14, further comprising:
a container heater configured to heat the target material container;
a container heater controller configured to control a heating operation of the container heater based on a temperature of the target material container or the target material; and
a container cover covering at least a portion of the opening and permitting rotation of the target material container about the axis of rotation and permitting irradiation with the quantum beam,
wherein the target material container is comprised of a material that can be inductively heated,
wherein the container heater includes an induction heating coil surrounding an outer side of the surrounding wall of the target material container, and
wherein the container cover has a side cover section extending between the outer side of the surrounding wall of the target material container and the container heater to cover at least a portion of the outer side.

26. The target holding device according to claim 13, further comprising:
a container heater configured to heat the target material container; and
a container heater controller configured to control a heating operation of the container heater based on a temperature of the target material container or the target material.

27. The target holding device according to claim 13, further comprising:
a container cover covering at least a portion of the opening and permitting rotation of the target material container around the axis of rotation and permitting irradiation with the quantum beam.

28. A system for quantum beam irradiation, comprising:
a target chamber in which a target material is allowed to be irradiated with a quantum beam produced by the quanta generator;
a gas supply system for supplying carrier gas to inside the target chamber;
an exhaust pipe for exhausting an ambient gas around the target material;
a trap device connected to the exhaust pipe for trapping a radionuclide in the ambient gas;
an exhaust pipe heater for heating at least a portion of a path of the exhaust pipe through which the ambient gas leads to the trap device; and
an exhaust pipe heater controller configured to control a heating operation of the exhaust pipe heater,
wherein the radionuclide is at least one of a first radionuclide produced from by irradiating a target nuclide contained in the target material with the quantum beam, or a second radionuclide, which is at least one of descendant nuclides obtained from the first radionuclide through radioactive decay.

29. A system for quantum beam irradiation, comprising:
the target holding device of claim 14; and
a quanta generator directed to have an irradiation axis toward the surrounding wall.

30. A system for quantum beam irradiation, comprising:
the target holding device of claim 13; and
a quanta generator configured to generate a quantum beam with an irradiation axis directed to the containing part through the opening.

31. A system for quantum beam irradiation, comprising:
the target holding device of claim 20; and
a quanta generator configured to generate the quantum beam with an irradiation axis directed within a horizontal plane.

32. A system for quantum beam irradiation, comprising:
the target holding device according to claim 13; and
a target chamber that houses the target material container and allows irradiation with quantum beams from the quanta generator while the target material container is driven in rotation.

33. The system according to claim 32, further comprising a gas supply system for supplying carrier gas to inside the target chamber.

34. The system according to claim 33, further comprising:
an exhaust pipe for exhausting ambient gas inside the containing part; and
a trap device connected to the exhaust pipe to trap a radionuclide in the ambient gas,
wherein the radionuclide is at least one of a first radionuclide produced from the target nuclide by irradiating a target nuclide contained in the target material with the quantum beam, or a second radionuclide, which is at least one of descendant nuclides obtained from the first radionuclide through radioactive decay.

35. The system according to claim 34, further comprising:
an exhaust pipe heater configured to heat the exhaust pipe; and
an exhaust pipe heater controller configured to control a heating operation by the exhaust pipe heater.

36. A target for quantum beam irradiation, comprising:
a target material container having a containing part and an opening through which the containing part is connected to an external environment and is rotatable about an axis of rotation passing through the containing part and the opening; and
a target material for quantum beam irradiation, which is contained in the containing part of the target material container in the form of either a solid, a liquid, or a mixture of the solid and the liquid.
